(19) United States
(12) Patent Application Publication
(10) Pub. No.: US 2005/0193055 A1
(43) Pub. Date: Sep. 1, 2005

(54) Context sensitive dynamic user interface for customer service agent

(76) Inventors: Mark Angel, Napa, CA (US); Marc Caltabiano, San Francisco, CA (US); Max Copperman, Santa Cruz, CA (US); Terri Czerwinski, Redwood City, CA (US); Scott B. Huffman, Redwood City, CA (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/787,548

(22) Filed: Feb. 26, 2004

(51) Int. Cl. G06F 15/16; G06K 9/64; G06F 17/30; G06F 17/60

(52) U.S. Cl. 709/202; 382/217; 709/204; 707/3; 705/1

(57) ABSTRACT

This document discusses, among other things, a system that receives context, such as from a customer relationship management (CRM) or other case tracking system, and uses the received context to formulate a customized inquiry resolution process, which is particularized to the customer inquiry. The customized process can be used by a customer service agent to resolve the customer inquiry. The customized process can create additional context which is written back to any calling system.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2003, Kanisa, Inc. All Rights Reserved.

### TECHNICAL FIELD

This patent application pertains generally to computerized information retrieval systems, and more particularly, but not by way of limitation, to a context sensitive dynamic user interface, such as for a customer service agent.

### BACKGROUND

A customer inquiry may occur in many different contexts. While some inquiries may be in-person between the customer and a customer service agent, other inquiries will take place by telephone or over a computer network such as the Internet. A customer may inquire for many different reasons, such as to obtain a good or service, to obtain information about a good or service, to solve a problem with a good or service, etc. One illustrative example would be a computer user contacting a manufacturer's help desk for assistance in using a hardware or software product. Another illustrative example would be a financial services customer seeking to effect a stock trade or other financial transaction. Yet another example would be a patient calling a nurse or doctor for medical advice. Many other examples exist. Because a customer inquiry represents a customer need, it may include a single question, several questions, or no question at all (e.g., a customer seeking to direct feedback to the appropriate channels within a business organization).

While many customer inquiries are handled by self-service tools, such as a website or an automated voice response system, other customer inquiries will be handled by a human customer service agent at a call center. Sometimes this will be a result of an “escalation” in the inquiry from a self-service mode to a human-service mode. Other times, the customer inquiry will be initiated directly to the customer service agent. Most consumers have at some time become frustrated with a self-service tool. When such customer inquiries are escalated to a human customer service representative, or even otherwise, maintaining customer goodwill requires that the customer be kept in a waiting queue for as short a period of time as possible, and that the customer service agent should be able to resolve the customer inquiry in as short a time as possible. However, employing customer service agents is expensive. Such human resources should be used as efficiently as possible. However, many computerized tools used by customer service agents to help resolve customer inquiries are clumsy and inefficient. Therefore, there is a need for improved computerized tools for resolving customer inquiries.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a block diagram illustrating generally one example of a portion of a computer-implemented system for assisting at least one human customer service agent in resolving a customer inquiry from at least one human customer/user.

FIG. 2 is a block diagram, similar to FIG. 1, but illustrating a particularly illustrative example in which the context storage device is part of a computer-implemented case tracking system.

FIG. 3 is a flow chart illustrating generally one technique for mapping context to a customized inquiry resolution process that is particular to a customer inquiry.

FIG. 4 is a computer display screenshot illustrating generally one example of a screen display output from a case tracking system.

FIG. 5 is a similar web browser screenshot in which a particular case has been selected for viewing within a case tracking system.

FIG. 6 is a screenshot example of a dynamic “Case Response” screen, provided by the system at the GUI, to provide a customized inquiry resolution process particularized to the customer inquiry using the context received from the case tracking system.

FIG. 7 is an example screenshot of the Case Response screen in which the Background tab is active and after information has been entered into the input fields of the Respond window and saved as context that has been or will be written back to the case tracking system.

FIG. 8 is an example screenshot of the Case Response screen in which the agent has switched from a Guided Search screen to an Advanced Screen that provides additional or different filtering and/or display options.

FIG. 9 is an example screenshot of the Case Response screen in which the Response To Customer tab is active in the Respond window.

FIG. 10 is an example screenshot of another Case Response for a different case from the case tracking system, resulting from the agent selecting the Resolve button integrated into the case tracking system.

FIG. 11 is an example screenshot of the Case Response screen of FIG. 10 after a number of interview questions have been asked, such that the customer inquiry has been diagnosed sufficiently to display a specific content file in the Interview screen being displayed in the Diagnose window.

FIG. 12 is an example screenshot of the Case Response screen of FIG. 10 with the Background tab activated after the interview.

FIG. 13 is an example screenshot of a Case Response screen for a different case in which the case title or other context is a specific error message, or is otherwise specific enough to warrant directing the agent to a particular “best content file.”

FIG. 14 is an example screenshot of a Case Response screen for a different case in which, at the end of the customized inquiry resolution process, the agent is unable to resolve the customer's inquiry.

FIG. 15 is an example screenshot of a Case Response screen for the case of FIG. 14 in which the defect has been reported and the Respond window 602 is preloaded with information to be included in an e-mail response to the user.

FIG. 16 is an example screenshot of a Case Response screen where the customized inquiry resolution process includes a collaboration with another.

FIG. 17 is an example screenshot illustrating a collaboration discussion thread around a particular case.

FIG. 18 is an example screenshot illustrating operation in response to activating the “Recommend Content” button 634 on the Case Response screen.

FIG. 19 is an example screenshot of an “Admin” web browser screen displayed on the GUI.

FIG. 20 is an example screenshot of a “Resolution Flow Rules” web browser page that includes matrix of rows and columns.

FIG. 21 is an example screenshot of an “Interview Designer” web browser page that provides a GUI for designing scripts for interviews by agents of users to assist in resolving customer inquiries.

FIG. 22 illustrates an example screenshot of a Contact Management screen of a financial services database display.

FIG. 23 illustrates an example screenshot of a Client Response dynamic screen triggered from the financial services database to provide a customized inquiry resolution process.

FIG. 24 is an example screenshot that illustrates an interview portion of the customized inquiry resolution process in the financial services example.

FIG. 25 is an example screenshot that illustrates a Background portion of the customized inquiry resolution process.

FIG. 26 is an example screenshot that illustrates an interview branch point that, based on a response to an interview question, initiates a call to another application.

FIG. 27 is an example screenshot that illustrates a dynamic screen representing a somewhat different customized inquiry resolution process in the financial services example.

FIG. 28 is an example screenshot that illustrates a dynamic screen representing yet another customized inquiry resolution process in the financial services example.

FIG. 29 is an example screenshot of an initial online web page for receiving a customer inquiry.

FIG. 30 is an example screenshot of a resulting dynamic screen for displaying the customized inquiry resolution process created by the system in response to received context.

FIG. 31 is an example screenshot of the dynamic screen in which the Suggested Results tab is active.

FIG. 32 is an example screenshot of the dynamic screen in which the Collaborate tab is active.

FIG. 33 is an example screenshot of the dynamic screen in which the Contact Call Center tab is active.

FIG. 34 is an example screenshot of an administrative graphical user interface for creating customized inquiry resolution processes and corresponding condition sets for triggering the same.

FIG. 35 is an example screenshot of a resulting “Select from Dictionary” screen that is displayed in response to the administrator activating the Add New Rule button.

FIG. 36 is an example screenshot of a subsequent form for defining the customized inquiry resolution process corresponding to the rule or condition set being created.

### DETAILED DESCRIPTION

In the following detailed description, reference is made to the accompanying drawings which form a part hereof, and in which is shown by way of illustration specific embodiments in which the invention may be practiced. These embodiments, which are also referred to herein as “examples,” are described in sufficient detail to enable those skilled in the art to practice the invention, and it is to be understood that the embodiments may be combined, or that other embodiments may be utilized and that structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. Any documents incorporated by reference or otherwise referred to herein are merely supplementary to the present document. In the event of inconsistent usages between the present document and those other documents, the usage in this document controls.

Some portions of the following detailed description are presented in terms of algorithms and symbolic representations of operations on data bits within a computer memory. These algorithmic descriptions and representations are the ways used by those skilled in the data processing arts to most effectively convey the substance of their work to others skilled in the art. An algorithm includes a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

1. Overview

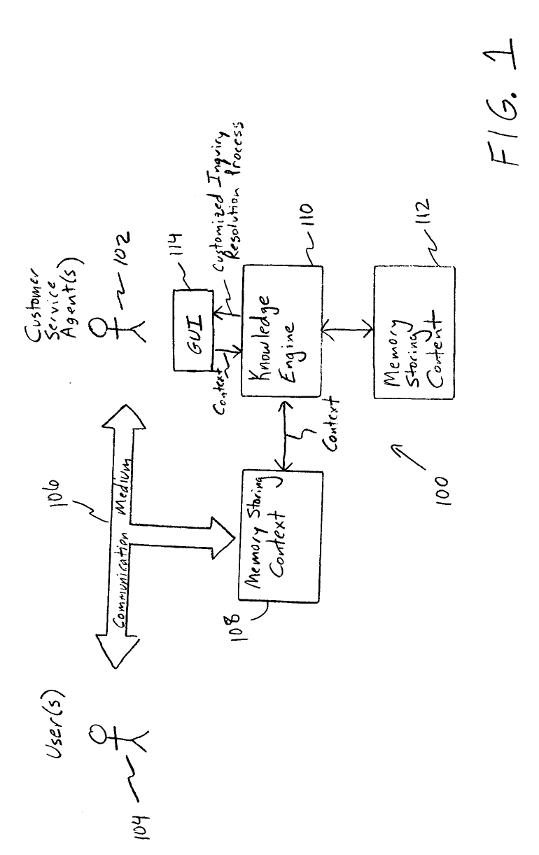

FIG. 1 is a block diagram illustrating generally, by way of example, but not by way of limitation, one example of a portion of a computer-implemented system 100 for assisting at least one human customer service agent 102 in resolving a customer inquiry from at least one human customer/user 104. The inquiry is typically communicated over a communication medium 106. The inquiry is typically initiated by the user 104. However, the customer inquiry could, in certain circumstances, instead be initiated by the agent 102, such as where the customer service agent is aware that the user 104 has such a need to be resolved. In the example of FIG. 1, at least one memory device 108 stores context, such as context from the session between the user 104 and the agent 102, as discussed below. A knowledge engine 110 is communicatively coupled to the context storage memory device 108 to retrieve context from and/or write-back context to the context storage device 108. The knowledge engine 110 is also communicatively coupled to at least one content storage memory device 112. The content storage device 112 stores content that is relevant to assist the agent 102 and/or the user 104 in resolving the inquiry. The knowledge engine 110 helps select the appropriate content needed to resolve the customer inquiry. A graphical user interface (GUI) 114 is communicatively coupled to the knowledge engine 110. The knowledge engine 110 uses the context received from the content storage memory 108 to drive a customized inquiry resolution process that is provided at the GUI 114 to the agent 102. This means that the process that the agent 102 uses to resolve a particular customer inquiry is tailored, by using the context, to that particular customer inquiry. This allows the customer inquiry to be resolved more quickly and effectively by the agent 102. The customized customer inquiry resolution process is also capable of writing additional context back to the context storage device 108, as discussed below.

2. Overview of Example Interfacing with Case Tracking System

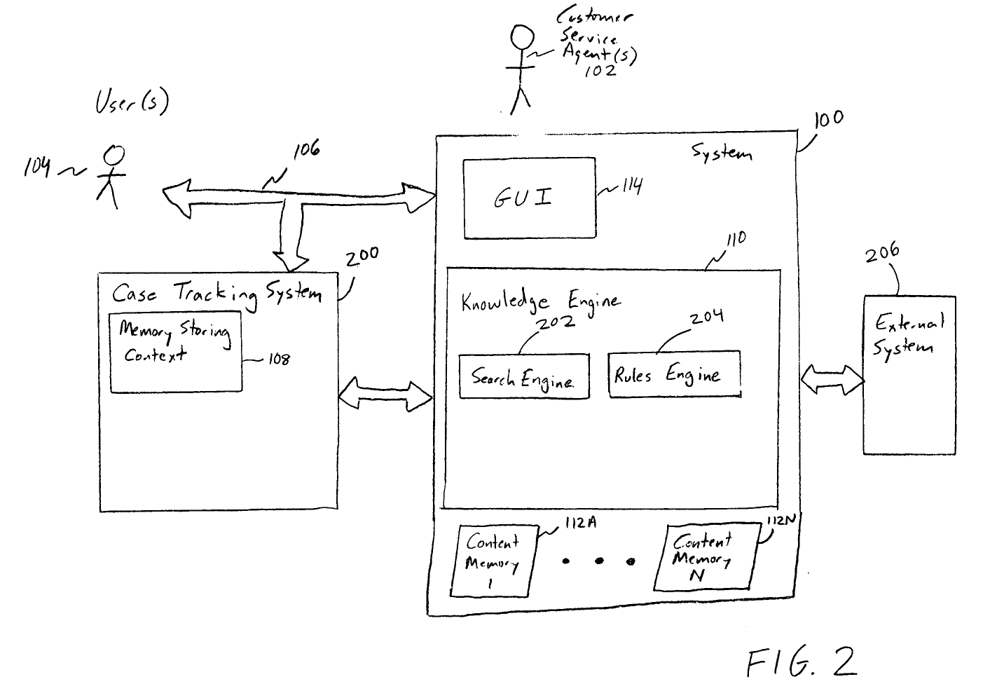

FIG. 2 is a block diagram, similar to FIG. 1, but illustrating a particularly illustrative example in which the context storage device 108 is part of a computer-implemented case tracking system 200. In the example of FIG. 2, the knowledge engine 110 includes a computer-implemented search engine 202 to steer the agent 102 toward appropriate content in at least one content storage device 112. The knowledge engine 110 also includes a computer-implemented rules engine 204 to map context received from the context storage device 108 in the case tracking system 200 to a customized inquiry resolution process, which is specific to a particular customer inquiry, for use by the agent 102 using the GUI 114. FIG. 2 also illustrates an example in which the system 100 optionally interacts with an external auxiliary computer-implemented system 206.

In the example of FIG. 2, case tracking system 200 tracks customer inquiries from various users 104. The case tracking system 200 typically opens a case for each such customer inquiry and assigns a case identification number to each such case. Context about the inquiry and its resolution is stored in the case. In one example, the case tracking system 200 is a computer-implemented customer relationship management (CRM) system. Such CRM systems are commercially available, such as from Siebel Systems, Inc., Amdocs Ltd., or PeopleSoft, Inc., for example. In one example, the system 100 interfaces to the external case tracking system 200 directly or by using a WebMethods or a custom application programming interface (API) that is included within the system 100. This interface allows the system 100 to pull in from the case tracking system 200 context associated with a particular customer inquiry. The received context may be stored by the system 100 in an internal or external volatile or nonvolatile memory, in a database, or otherwise. The context can take different forms such as, for example, a set of a few or many (attribute, value) pairs. This can be implemented in a self-describing fashion using extensible markup language (XML), for example, in which XML tags denote the attributes, and either text or other XML attributes denote the values. For example, WebMethods supports transforming the context from the system 200 using a graphical tool, such as to put the context into (attribute, value) pairs, if needed. The rules engine 204 then determines which of this context will be useful for resolving the customer inquiry, and maps that context to a customized inquiry resolution process that is particular to that customer inquiry.

In the example of FIG. 2, the GUI 114 is communicatively coupled to both the case tracking system 200 and the knowledge engine 110. This allows the GUI 114 to display screen information from applications being run on both system 200 an system 100, as discussed below. In one example, the agent 102 can toggle back and forth between web browser pages from each of the two systems.

3. Examples of Context and Its Sources

The context stored by the case tracking system 200 can include text, metadata, or other data. The stored context data can represent many different types of information about the particular customer inquiry session. Examples of such context include, without limitation: (1) customer profile or account information such as customer name, address, telephone number, e-mail address, account number, etc.; (2) a description of the nature of the inquiry, such as provided by the user 104 or added by the agent 102; (3) agent profile information such as agent name, experience level, areas of particular expertise, etc.; (4) information about a customer's products or services relevant to the inquiry (e.g., model number, serial number, service contract subscription, etc.); (5) channel information about which channel originated the customer inquiry (e.g., telephone, web page, e-mail, etc.); (6) channel management system information (e.g., queuing information, caller identification information, e-mail handler information, etc.); (7) session information that has accumulated from the originating channel and/or during the initial portions of the customer inquiry; (8) information about previous customer inquiries or other previous contacts with the user 104; (9) information about the user's computer, telemetry, or communication equipment; (10) previously obtained information about the same customer inquiry; or (1) information obtained from the user's computer, telemetry, or communication equipment, such as log files, system settings, or other files or data, such as were such information is obtained using the WMI or CIM standards.

Context stored in the context storage device 108 of the case tracking system 200 can be obtained from many different sources and in many different ways. Examples of sources of context include: (1) the user 104; (2) the user's computer or other communication equipment; (3) the agent 102; (4) the agent's computer or other communication equipment; (5) a third party; and/or (6) the third party's computer or other communication equipment. Examples of ways of receiving the context include, without limitation: (1) context received by telemetry, such as product identification information stored as cookies or otherwise on the customer's computer, which are automatically obtained by the case tracking system 200; (2) context received in one or more electronic mail messages; (3) context entered by into one or more web forms by the user 104 or agent 102; (4) context received from one or more postings on a threaded or other web discussion forum; (5) context obtained from one or more natural language queries by the user 104 or agent 102 (e.g., to a web or other search engine); (6) context obtained as output from a telephonic or other interactive voice response system, such as which asks prompting questions and receives responsive information by voice or number pad selection; (7) context obtained from one or more chat sessions using one or more instant messaging systems, such as available from Microsoft Corp. or Yahoo!, Inc.; and/or (8) context obtained as output from a voice recognition system. Moreover, the context can be obtained from the customer in a single session or in multiple sessions with the same or a different agent 102 or with a self-service customer assistance device.

4. Examples of Customized Inquiry Resolution Processes

The knowledge engine 110 includes a rules engine 204 that maps appropriate context from a particular customer inquiry to a customized inquiry resolution process that is particular to that inquiry. In one example, customizing the inquiry resolution process includes choosing at least two items for the agent 102 to use in resolving the inquiry. Having such a suite of preselected items available for resolving the inquiry improves the agent's efficiency and accuracy. Examples of such items are listed below.

A. Search Engine. In one example, the customized inquiry resolution process includes a search engine to steer the agent 102 toward appropriate content for resolving the inquiry. In one example, the customized process preconfigures the search engine screen so that it appears on the agent's GUI either (1) having already run a search using the context obtained from the case tracking system 200; or (2) pre-loaded with the context and ready to run a search using the same. This improves the agent's efficiency. Although many different search engines can be used in this manner, one useful example is described in Copperman et al. U.S. patent application Ser. No. 10/047,446 entitled EFFICIENT AND COST-EFFECTIVE CONTENT PROVIDER FOR CUSTOMER RELATIONSHIP MANAGEMENT (CRM) OR OTHER APPLICATIONS, which was filed on Jan. 14, 2002 is assigned to Kanisa, Inc., and which is incorporated by reference herein in its entirety, including its description of a guided search engine.

B. Script. Customer service agents 102 often use scripts to tell them what to say to a particular user 104. The customer service agent 102 will typically have many different scripts to choose from, the different scripts individually tailored to different types of customer inquiries. However, it takes time for the customer service agent 102 to locate the appropriate script. Therefore, in one example, the customized inquiry resolution process uses the context to choose one or more particular scripts to automatically appear preloaded for display on the GUI 114. This reduces or avoids the time needed for the customer service agent 102 to locate the appropriate script, which, in turn, improves the agent's efficiency. An interview can add further context to the existing context already associated with the customer inquiry.

C. Collaborative or Escalative Session with Another. A customer service agent 102 may not always be able to individually resolve a particular customer's inquiry. Different customer service agents 102 have different experience levels and different areas of particular subject-matter expertise. Therefore, collaboration between customer service agents 102 may be the best way to resolve a particular customer inquiry. In one example, the customized inquiry resolution process uses the context (e.g., agent profiles, problem description, etc.) to automatically suggest and/or select another agent 102 who has the appropriate experience and/or subject-matter expertise to help the originating agent 102 in resolving that particular customer inquiry (i.e., collaboration). In a further example, this includes initiating a communication session between the two agents 102 using their individual GUIs 114, such as by electronic mail, an instant messaging session, or a threaded discussion that can grow to include other agents as well. In another example, the collaboration between agents includes an escalation, i.e., the receiving agent assumes responsibility for further handling of the customer inquiry, and the originating agent is relieved of further handling that customer inquiry. In general, context can be used to steer a particular customer inquiry to an appropriate agent, either with or without a collaboration between two agents.

D. Response to the User. A customer service agent 102 may respond to a customer inquiry by an e-mail message or the like. In one example, the customized inquiry resolution process uses the context to choose a particular e-mail or other response template to automatically appear preloaded for display on the GUI 114. The agent 102 can send this preloaded response, or may edit it further before sending. This reduces or avoids the time needed for the agent 102 to draft an appropriate response, or to locate an appropriate response template to resolve the customer's inquiry.

E. Response to the Case Tracking System. As the customer service agent 102 uses the customized inquiry resolution process to resolve the customer's inquiry, more context is typically created. For example, such additional context may be entered by the agent 102 as the agent further discusses the inquiry with the user 104, or as a result of using the search engine 202 to retrieve needed content. Because such additional context may be helpful for resolving a future inquiry by the same customer, or for diagnosing trends in inquiries across many different customers, such as in relation to a particular product or service, it may be desirable to include such additional context with other context from the same case stored in the context storage device 108 in the case tracking system 200. Therefore, in one example, the system 100 is operable to write back context to the case tracking system 200. This may be particularly important, for example, where the agent 102 is unable to adequately resolve the customer inquiry, such that the case remains open as a “bug” to be reported to a more senior agent or other groups in the business organization, such as engineering personnel and/or content developers that create the content that is accessed by the knowledge engine 110.

F. Interaction with and/or Response to an External Computerized

System. As the customer service agent 102 uses the customized inquiry resolution process to resolve the customer's inquiry, under some circumstances, the system 100 accesses one or more external systems 206. For example, where a user 104 wishes to return merchandise, it may be that the system 100 needs to interact with an external computerized accounting system or the like to obtain return authorization or other information. Not only does such an external access generate additional session context or content, it may also be desirable to write back a response to the accessed external system 206. Therefore, in one example, the customized inquiry resolution process uses already-acquired session context to initiate access to the external system 206 and/or to provide responsive data to the external system 206.

G. At least one content file. Content files include various representations of knowledge that could assist in resolving the customer's inquiry. Examples of content files include, without limitation, textual or other documents, graphic images, video or audio clips, a hyperlink or other link to an application or stored information, or interactively generated reports. For certain common or well-defined inquiries, the context from the case tracking system 200 is capable of identifying a “best content file” or a small set of “best content files” without using a search engine, but by instead mapping the context directly to such a best content file or content files using one or more predefined rules. Therefore, in one example, the customized inquiry resolution process includes using the context, by applying one or more rules, to select at least one content file to be preloaded for display onto the GUI 114.

The customized inquiry resolution process may be configured in a number of different ways, examples of which are listed below.

A. In one example, the context is used to choose at least two of the above items to present to the agent 102 for resolving the inquiry. This effectively provides a pre-selected suite of inquiry resolution options for the agent, based on context received from the case tracking system 200. This, in turn, helps the agent 102 be more efficient and accurate in resolving the customer inquiry.

B. In a further example, the context is also used to choose a sequence in which the chosen inquiry resolution options are presented to and/or used by the agent 102. As an illustrative example, the best content files are presented to the agent 102 first, followed by a search for content, followed by a collaboration with another agent 102. In one example, the different acts in the customized inquiry resolution process serve as branchpoints to more than one subsequent act. As an illustrative example, if the agent 102 can resolve the customer inquiry using the best content files that were presented to the agent 102, then the next act would alternatively be to present a response template to the agent 102 to allow the agent 102 to send the response to the user 104. Otherwise, the agent 102 would proceed to the next act in the above sequence, i.e., the search for content, as discussed above. The sequence of the customized inquiry resolution options can optionally be overridden by the agent 102. This would permit, for example, the agent 102 to skip directly to the collaboration with the other agent 102.

C. In another example, the context is also used to choose the content that is provided for at least one of the chosen customer inquiry resolution options. For example, where one of the chosen customer inquiry resolution options includes presenting a content file to the agent 102, the content provided in that content file is also determined by the context. In another example, where one of the chosen customer inquiry resolution options includes offering a collaboration with another agent 102, then the particular content (e.g., a list of potential other agents 102 for the collaboration) is determined by the context. For example, where the context indicates a first problem, then the list of collaborators would include agents 102 having profiles indicating experience with that first problem; where the context indicates a second problem, then the list of collaborators would include a potentially different list of agents 102 having profiles indicating experience with the second problem. In another example, the context is used to choose a response form from a set of such responses forms, or to pre-populate a response form to the user 104 or another system. In yet another example, the context is used to tailor a response form or the like such as, for example, to tailor a Case Note to capture feedback from agents 102 on customers' issues with respect to a particular product or service.

D. In another example, the context is also used to instantiate context into content. For example, if the customized inquiry resolution process includes an option for creating a response to the user 104, then, in one example, the response template is pre-populated with the user's name, e-mail address, hardware or software configuration, or other appropriate context obtained from the case tracking system 200.

E. In yet another example, the context is used to customize at least one of the customer inquiry resolution options. In an illustrative example, the context is used to determine how a search is performed, such as by being used as input to the search engine. In another illustrative example, the context is used to determine how a collaboration between agents 102 should take place (e.g., via a forum post, or instant messaging, etc., based on agent profiles).

5. Rules Engine Example

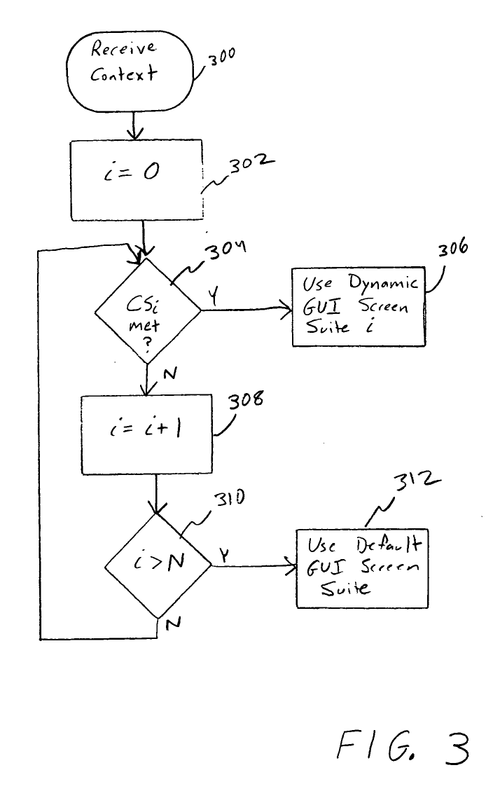

Although the rules engine 204 can be implemented in numerous different ways, the flow chart of FIG. 3 illustrates generally one technique for mapping context to a customized inquiry resolution process that is particular to a customer inquiry. This illustrative example includes a set of N different customized inquiry resolution processes, each resulting in a different dynamic screen suite of inquiry resolution options. In the example of FIG. 3, at 300, context is received by the rules engine 204, such as from the case tracking system 200. At 302, a counter i is set to zero. At 304, if a particular set of one or more conditions (i.e., CSᵢ) on the context is met, then the “ith” one of the customized inquiry resolution processes (which includes a suite of more than one inquiry resolution item, as discussed above) is provided at the GUI 114. Otherwise, the counter is incremented at 308. If, at 310, all the condition sets have been tested, then, at 312, a default customized inquiry resolution process is provided at the GUI 114. Otherwise, process flow returns to 304 to test the next condition set until either one of the condition sets is met or until all condition sets are exhausted. Thus, in this example, the sequence of testing reflects a prioritization among condition sets to prefer customized inquiry resolution processes that appear earlier in the list over customized inquiry resolution processes that appear later in the list, provided that the appropriate conditions on the context are met. This example is merely illustrative; many other techniques are possible.

6. Customer Inquiry Resolution Flow Example

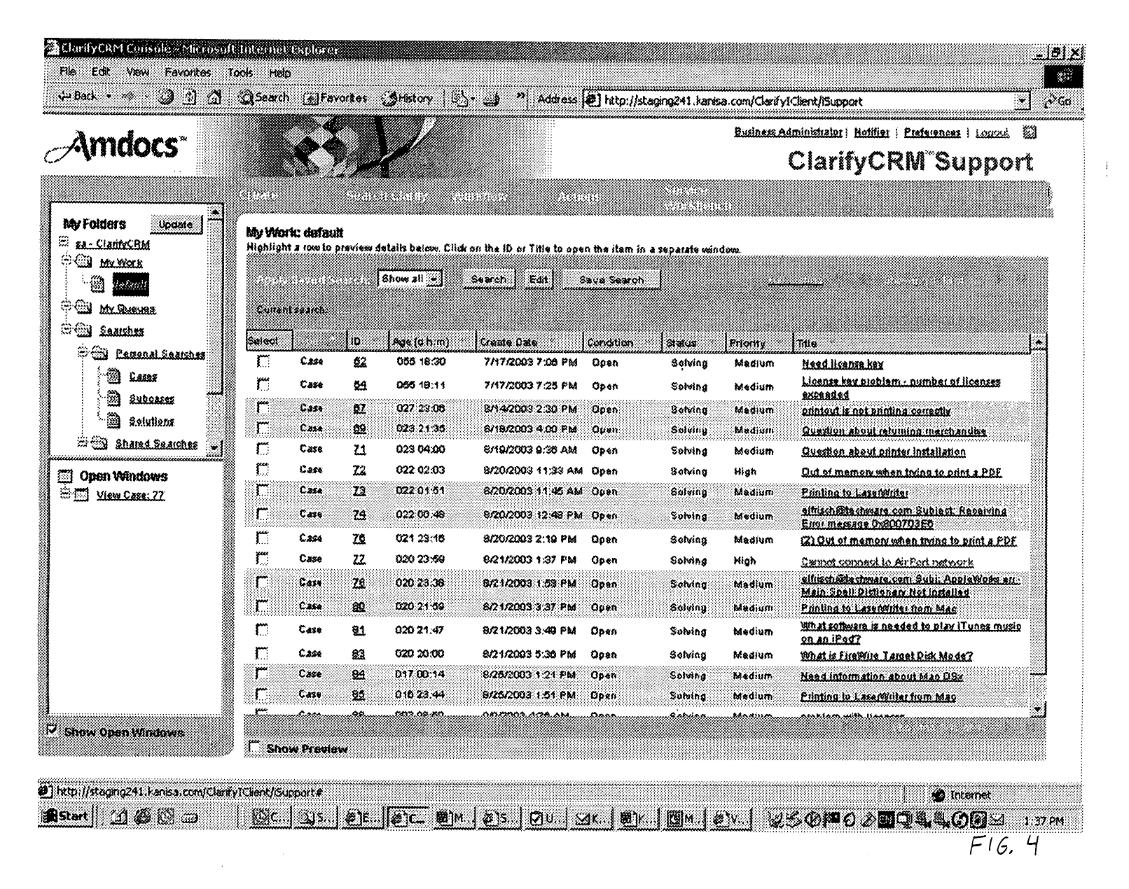

FIG. 4 is a computer display screenshot illustrating generally one example of a screen display output from a case tracking system 200, such as ClarifyCRM available from Amdocs Ltd. The example of FIG. 4 lists various cases, each case representing a customer inquiry. Each case is assigned an identification (ID) number. The display also provides the age (time since creation) of each case, the creation date of each case, the condition of each case (e.g., “open,” “closed” as resolved or as a known bug, etc.), the status and priority of each case, and the title of each case. The title of each case can come from different sources, such as the subject line from an e-mail inquiry by a user 104, or entered in by an agent 102 during a customer inquiry session.

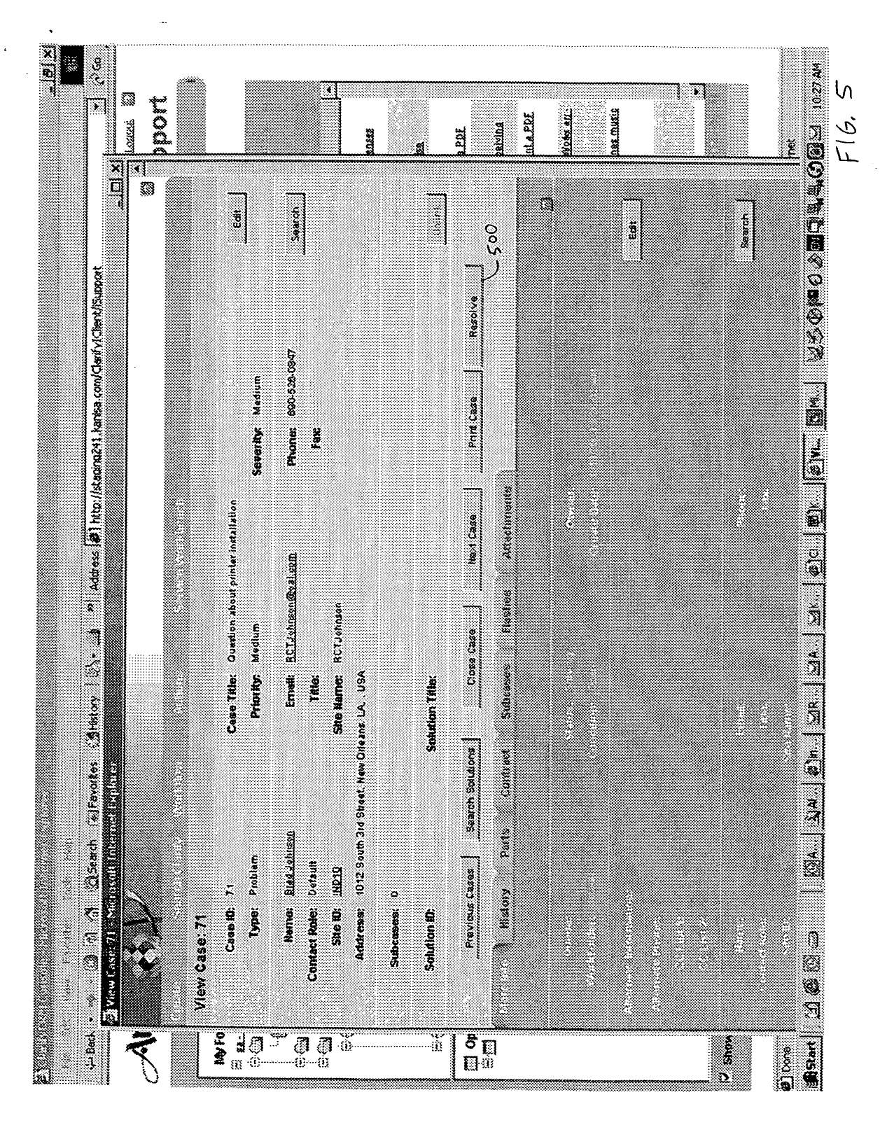

FIG. 5 is a similar web browser screenshot in which a particular case has been selected for viewing within the ClarifyCRM example of case tracking system 200. It includes additional context information about the case, such as the customer's name, physical address, e-mail address, phone number. This web browser interface also includes a “Resolve” button 500. When the agent 102 selects the Resolve button 500, the case tracking system 200 calls the system 100 to assist the agent 102 in resolving the particular customer inquiry. The case tracking system 200 provides the system 100 with its accumulated context regarding the particular case. In response to the received context, the rules engine 204 provides to the GUI 114 a customized inquiry resolution process, particular to the case.

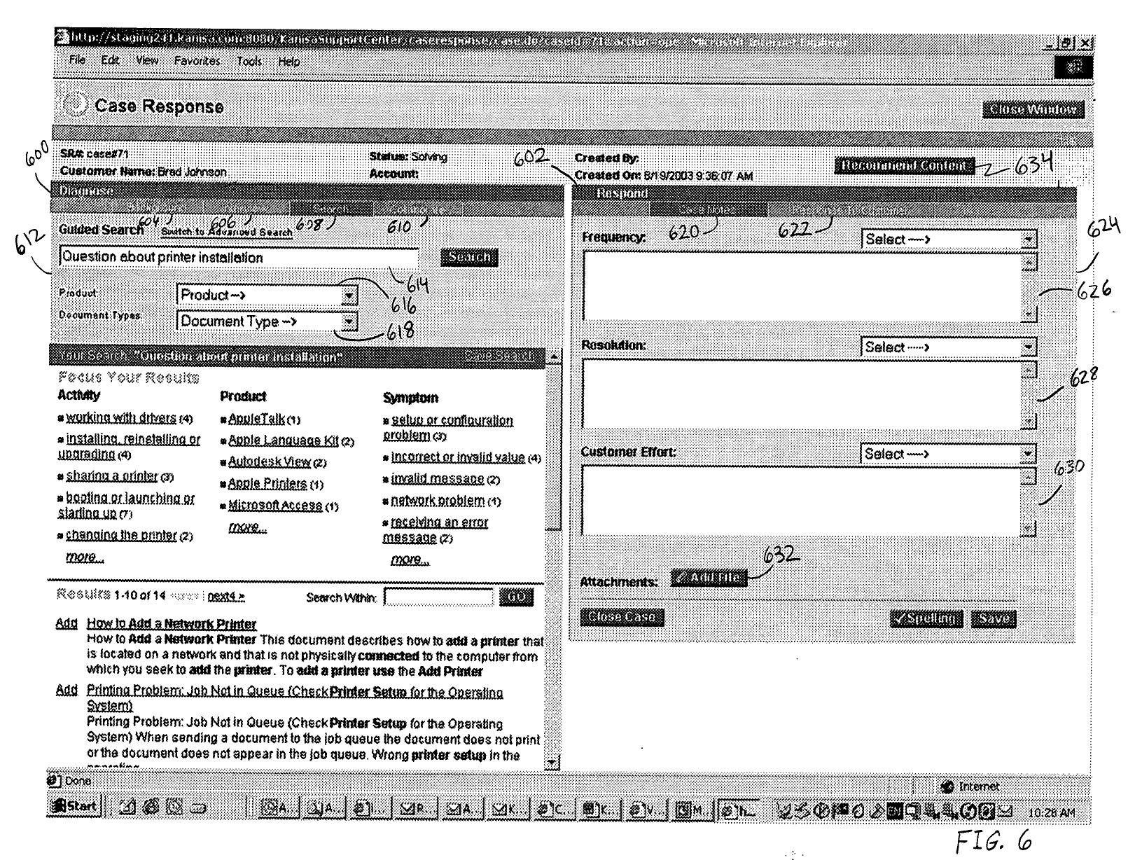

FIG. 6 is a screenshot example of a dynamic “Case Response” screen, provided by the system 100 at the GUI 114, to provide a customized inquiry resolution process particularized to the customer inquiry using the context received from the case tracking system 200. In this example, the Case Response screen is split into a “Diagnose” window 600 and a “Respond” window 602, to help diagnose the customer's problem or inquiry and to help respond to the customer, respectively.

In this example, the Diagnose window 600 includes a “Background” tab 604, an “Interview” tab 606, a “Search” tab 608, and a “Collaborate” tab 610, each of which trigger respective individual screens in the Diagnose window 600, and each of which represents a different option included in the customized inquiry resolution process. In one example, the customized inquiry resolution process also selects a sequence of presenting these various screens to the agent 102. In one example, this sequence is reflected in the order in which the tabs appear on the screen (e.g., left-to-right). In another example, the sequence is independent of the order in which the tabs appear on the screen. However, these tabs represent one technique of many for depicting the various acts of the customized inquiry resolution process that are available to or used by the agent 102. In another example, the various acts of the customized inquiry resolution process are represented by hyperlinks. In yet another example, the customized inquiry resolution processes is represented by a “wizard,” which is computer jargon for an onscreen sequence of windows that guides the user through procedures or processes. In general, there are many different ways of representing the customized inquiry resolution process, as well as the different acts comprising the customized inquiry resolution process.

In the example of FIG. 6, the Search tab 708 has been selected, such that a Guided Search screen is displayed in the Diagnose window 600. The Guided Search screen 612 is configured to permit the agent 102 to search a content repository for content needed to resolve the customer inquiry. In one example, the Guided Search screen 612 includes a natural language Query form input 614. It may also include various filter form inputs to further constrain the search, such as a Product filter 616 and a Document Type (i.e., content file type) form input 618. In one example, context from the case tracking system 200 is used to preload one or more of these form inputs, thereby avoiding any need for the agent 102 to enter the same information that is already available from the case tracking system 200. In a further example, as illustrated in FIG. 6, the search query is also automatically executed using a search query that is constructed by the system 100 using the context, so that the screen appears to the agent 102 with search results already available. The agent 102 can then either access the content or further refine the search toward a narrower or broader set of search results. In one example, the content is assigned to groups (e.g., “Activity,” “Objects,” “Product,” “Symptom,” etc.) and the Guided Search makes use of these groups, such as described in the above incorporated Copperman et al. U.S. patent application Ser. No. 10/047,446.

In the example of FIG. 6, the Respond window 602 includes a “Case Notes” tab 620 and a “Response To Customer” tab 622, each of which trigger respective individual screens in the Respond window 602, and each of which represents a different option included in the customized inquiry resolution process. In one example, the customized inquiry resolution process also selects a sequence of presenting these various screens to the agent 102. In one example, this sequence is reflected in the order in which the tabs appear on the screen (e.g., left-to-right). In another example, the sequence is independent of the order in which the tabs appear on the screen.

In the example of FIG. 6, the Case Notes tab 620 has been selected, which triggers display of a Case Note web form 624 template for entering information about the customer inquiry, where such information will be written back as additional context to the case tracking system 200 as a case note. In this example, the Case Note web form 624 includes a “Frequency” input field 626, a “Resolution” input field 628, and a “Customer Effort” input field 630, each with its own drop down menu that can include content templates that can be selected for inclusion in the corresponding input field, but also permitting additional editing by the agent 102. The Case note web form 624 also includes an “Attachments” button 632, such as for attaching content or other electronic files to the case note that is written back to the case tracking system 200. The Case Response screen also includes a “Recommend Content” button 634, which triggers a process for recommending that additional content be created to fill a content hole, such as where an agent 102 cannot adequately resolve a customer inquiry.

In general, Case Notes act to fill the leak of information that is typically scratched on an agent's notepad at the end of the shift. Agents 102 often use notepads to capture information from the user 104 that may not be used directly to find the answer, but which is still useful (e.g., “Yesterday I tried this three times . . . ” “I tried to reboot the computer . . . ”). Such information is important to capture and save as part of the case. The Case Notes area enables this information to be captured in electronic form. It also prompts the agent 102 on some information categories that should be discovered from the user 104, if possible, and typically provides predefined text selections for quick capture.

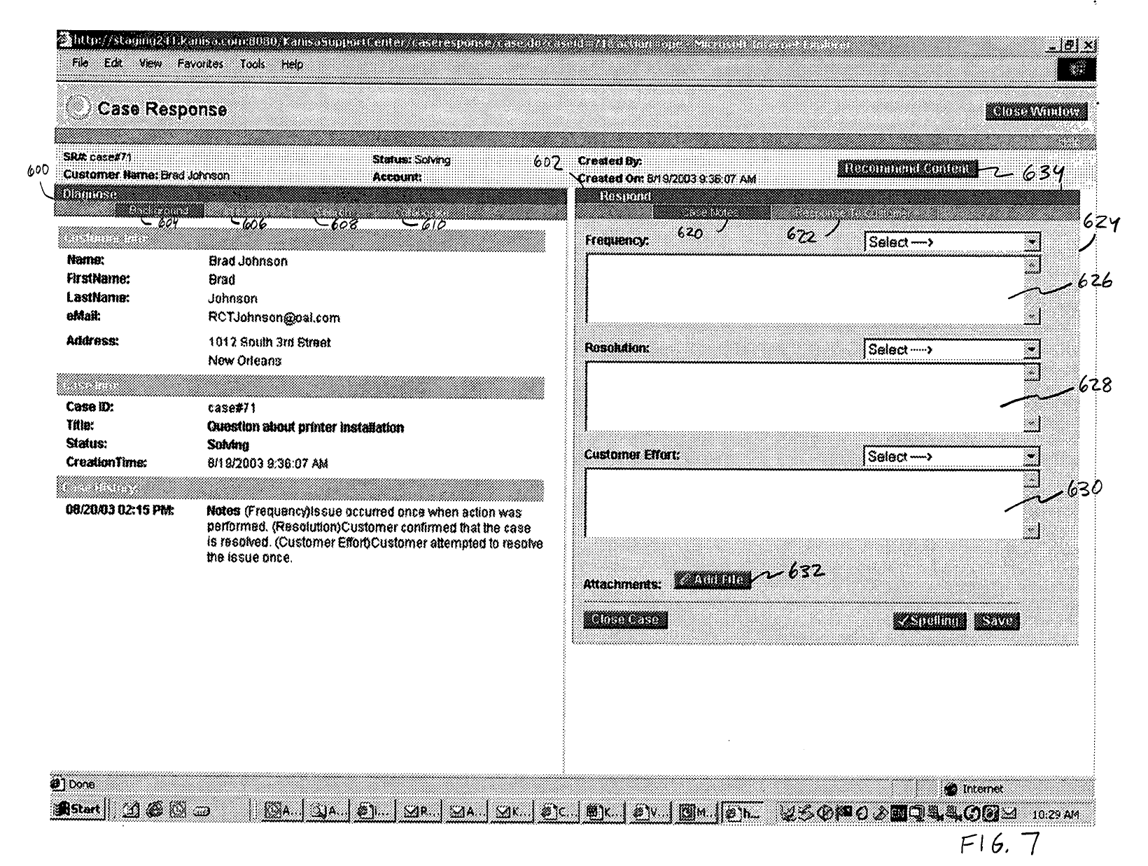

FIG. 7 is an example screenshot of the Case Response screen in which the Background tab 604 is active and after information has been entered into the input fields of the Respond window 602 and saved as context that has been or will be written back to the case tracking system 200. Selecting the Background tab 604 activates a Background screen 700 in the Diagnose window 600. The Background screen 700 displays context associated with the particular case being resolved. Such displayed context is received from the case tracking system 200 and/or created during the customized inquiry resolution process. In this example, the Background screen 700 includes separate areas for displaying customer information, case information, and case history information.

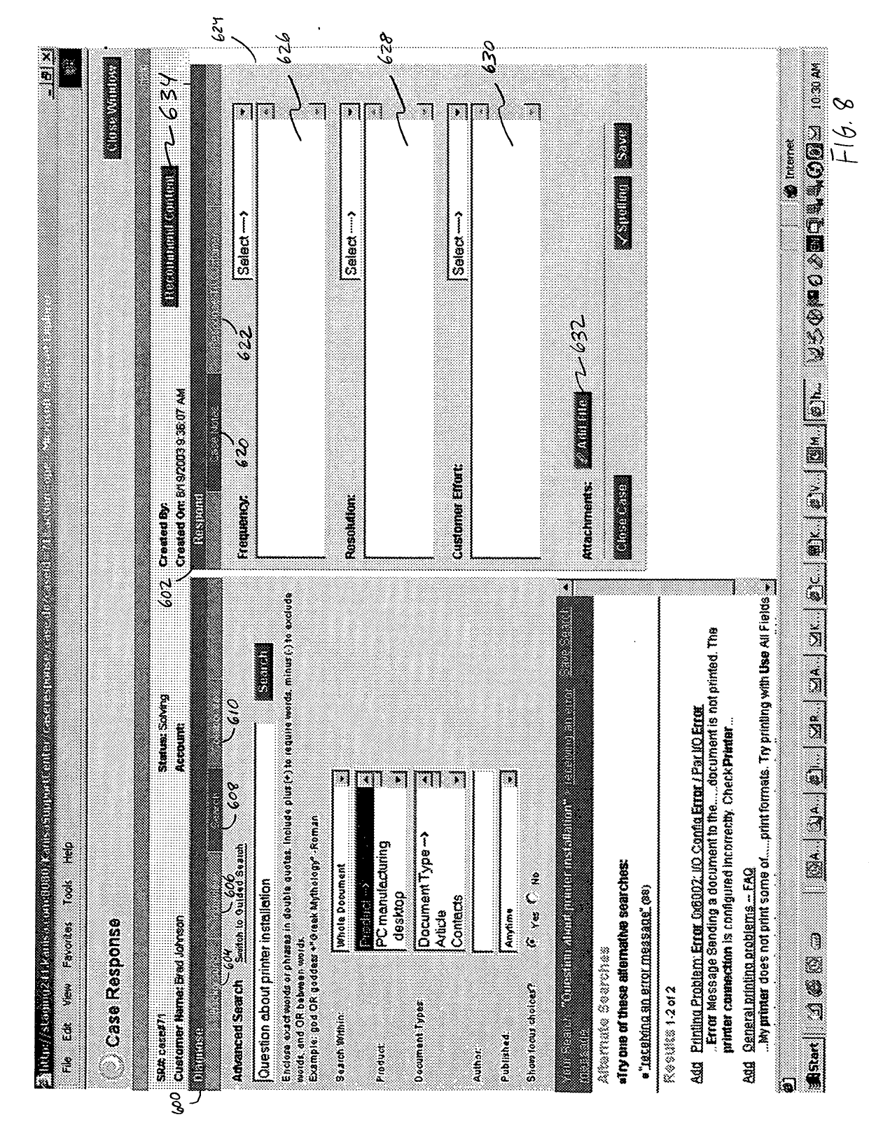

FIG. 8 is an example screenshot of the Case Response screen in which the agent 102 has switched from a Guided Search screen to an Advanced Screen that provides additional or different filtering and/or display options (e.g., Author, Publication Date). FIG. 8 also illustrates an example in which the search has yielded few returned content hits, such that a broadening “Alternate Search” is suggested to the agent 102, such as described in the above incorporated Copperman et al. U.S. patent application Ser. No. 10/047,446.

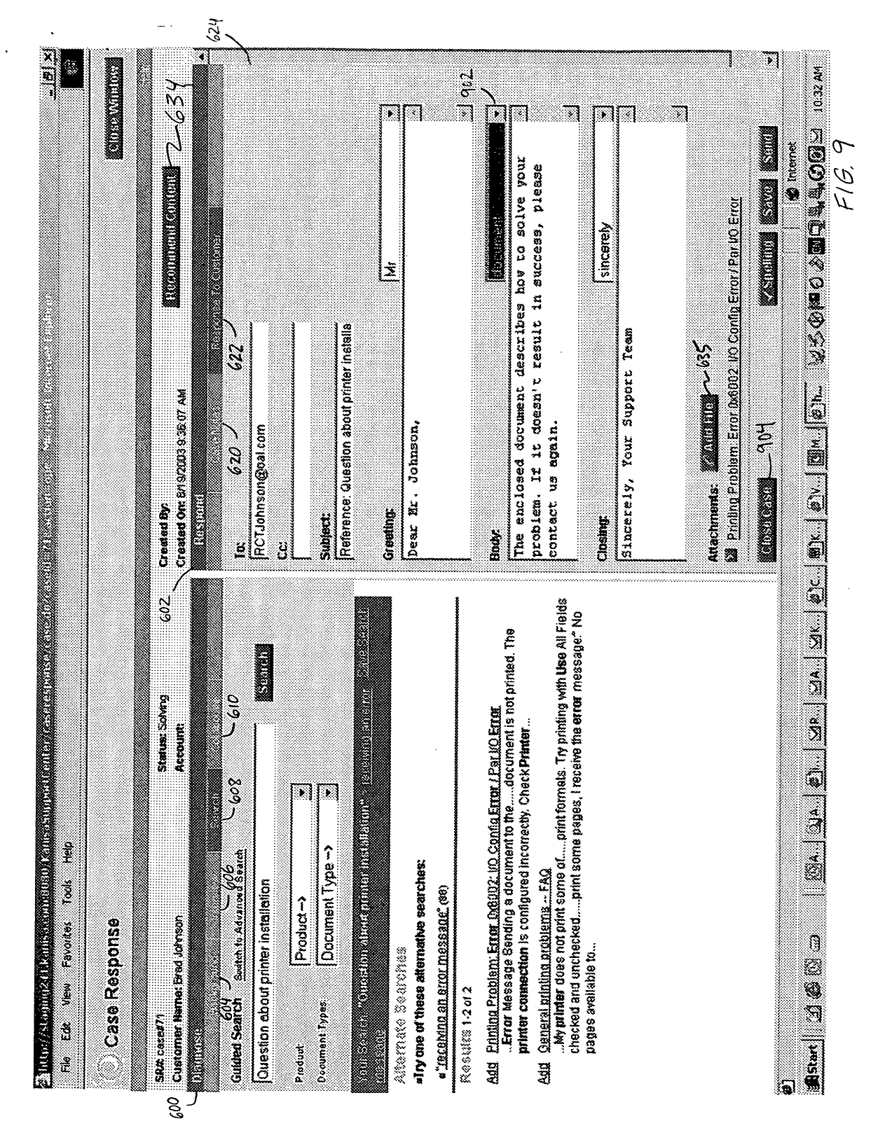

FIG. 9 is an example screenshot of the Case Response screen in which the Response To Customer tab 622 is active in the Respond window 602. In this example, this triggers an electronic mail message template that includes “To”, “CC”, “Subject,” “Greeting,” “Body,” and “Closing” fields. In one example, one or more of these fields is preloaded using context received from the case tracking system 200 or created earlier during the case response. The template includes one or more pull-down menus that provide one or more options that the agent 102 can select to insert predefined content into the Body portion of the electronic mail response to the user. In the example of FIG. 9, the agent 102 has selected “document” from the pull-down menu 902 associated with the Body portion of the electronic mail response to the user. This inserts predefined text into the Body. The inserted text provides an explanation to the user 104 that is appropriate when the agent 102 has used the search facility in the Diagnose window 600 to locate a particular document or other content file in the content storage device 112, and attached that content file to the e-mail response to the user 104 using the Add File button 635, or by dragging and dropping an icon associated with the content from the Diagnose window 600 to the Respond window 602.

For many case types, there are three or four very common answers to problems that would be used 25 or 50% of the time. Agents 102 know about these answers and want to be able to pull from these and quickly send to the user 104. In the Body pulldown menu, there is some of the boilerplate text that will show up for every email, but there may also be some items such as “printer driver conflict” that only show up for problems about printers—they will not be there for other types of cases. Thus, the content choices may be customized to the particular case using the context received from the case tracking system 200 or accumulated later.

When the agent 102 selects the “Close Case” button 904, the Case Response screen is closed and agent 102 is returned to the case view screen of the case tracking system 200, which receives the context that was added by the system 100 when the Case Response screen was active. In one example, the agent 102 can toggle between the Case Response screen of the system 100 and a View Case or other screen of the CRM or other case tracking system 200.

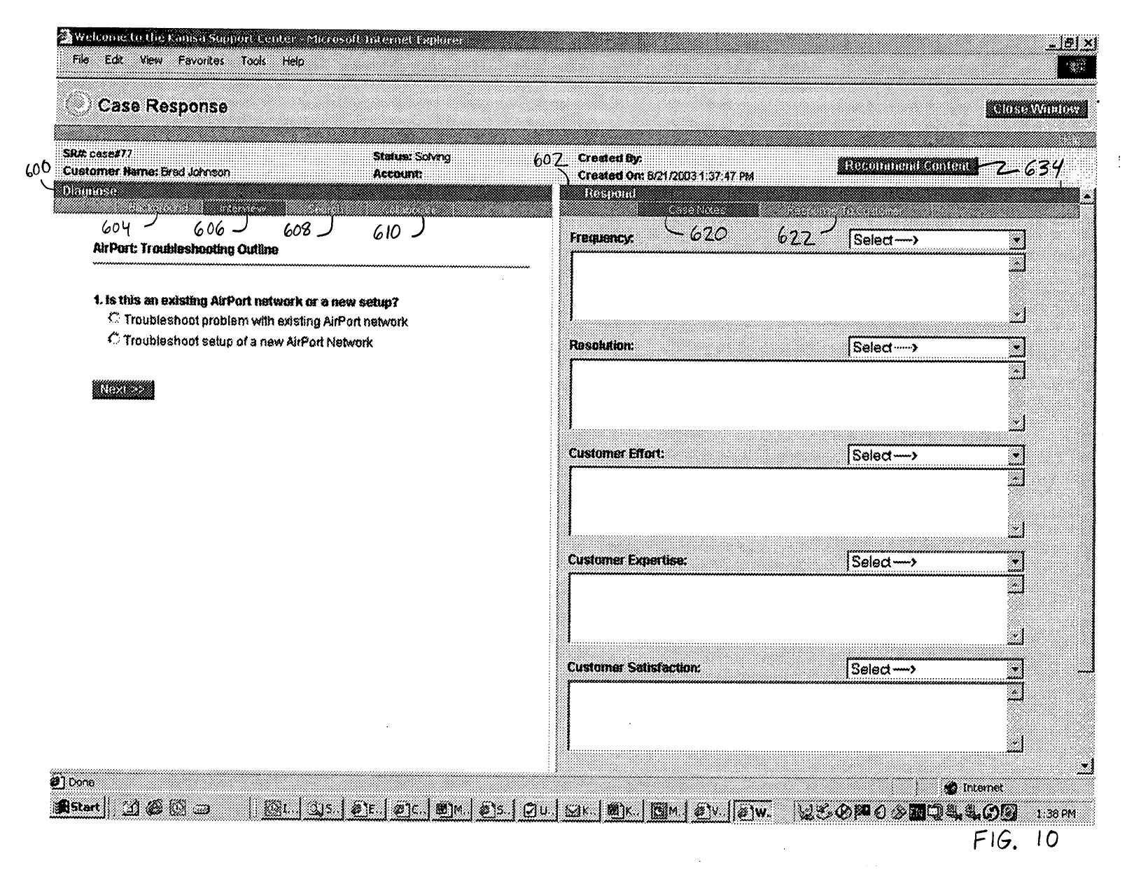

FIG. 10 is an example screenshot of another Case Response for a different case from the case tracking system 100, resulting from the agent 102 selecting the Resolve button 500 integrated into the case tracking system 200. In this example, the context received by the system 100 from the case tracking system 200 includes the case title “Cannot connect to AirPort network.” The response engine 204 maps this particular context to a different customized inquiry resolution process that is particularized to this case. This brings up the Case Response screen illustrated in FIG. 10, with the Interview tab 606 already activated to display a script for the agent 102 to use in a dialog with the user 104 to help resolve the customer inquiry. The script is particularized to the case using the context. During the dialog, additional context is created by the agent 102 by selecting certain responses that match the user's responses to questions in the script. The interview helps guide the agent 102 toward resolving the customer's inquiry. In general, the interview need not be limited to asking questions and receiving responses, but may also include giving guidance help instead of asking questions, for example. The additional context created during the interview may be used as a branch point in the interview (e.g., to branch to one of different questions or to branch to one or more different subsequent customized inquiry resolution processes).

In general, the interview between the agent 102 and the user 104 may end in a number of different ways. For example, the interview may end with the agent 102 using the Respond window 602 to draft an e-mail or other response to the user 104. In another example, the interview may end with the agent 102 using the Respond window 602 to draft a Case Note to the case tracking system 200. In another example, an interview ends by initiating yet another customized inquiry resolution process, which may be selected using the additional context accumulated during the interview, e.g., by the user's response to various questions, etc. This additional context is passed to the newly initiated customized inquiry resolution process (e.g., to launch a search using the previous and new context, for example). In another example, after the interview ends, the rules engine 204 uses the context accumulated during the interview, in addition to the previous context, to determine which new customized inquiry resolution process should be initiated, if any.

The Case Response screen illustrated in the example of FIG. 10 is also brought up, based on the context from the case tracking system 200, with the Case Notes tab 620 activated. This results in the display of a particular Case Notes template, in the Response window 602, that is tailored using the context. In this example, the Case Notes template is tailored for use with the accompanying Interview in the Diagnose screen 600, such as to include “Frequency,” “Resolution,” “Customer Effort,” “Customer Expertise,” and “Customer Satisfaction” input forms. Each input form is accompanied by a corresponding pulldown menu, which allows the agent 102 to drop predefined content into the input forms. These Case Notes are a very effective tool for an organization to capture information on certain problems. For example, if the organization has recognized that there seems to be an increasing number of cases about doing a fresh install of a software package for a particular operating system version, they can add some additional pieces of information to the Case Notes that they would like the agents 102 to capture for analysis reasons.

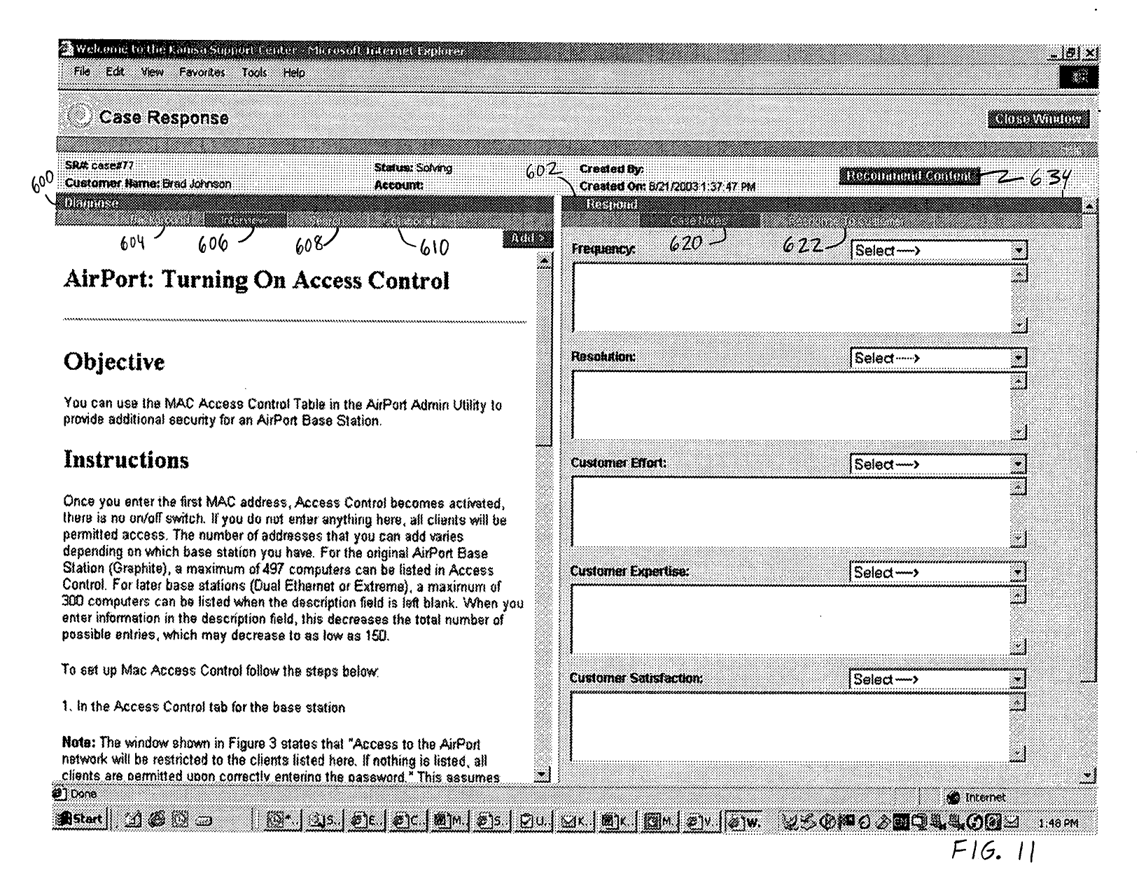

FIG. 11 is an example screenshot of the Case Response screen of FIG. 10 after a number of interview questions have been asked, such that the customer inquiry has been diagnosed sufficiently to display a specific content file in the Interview screen being displayed in the Diagnose window 600. In another example, after a number of interview questions have been asked, the customer inquiry will have been diagnosed sufficiently to initiate a specific guided search for content using the context accumulated thus far, instead of displaying the particular content file.

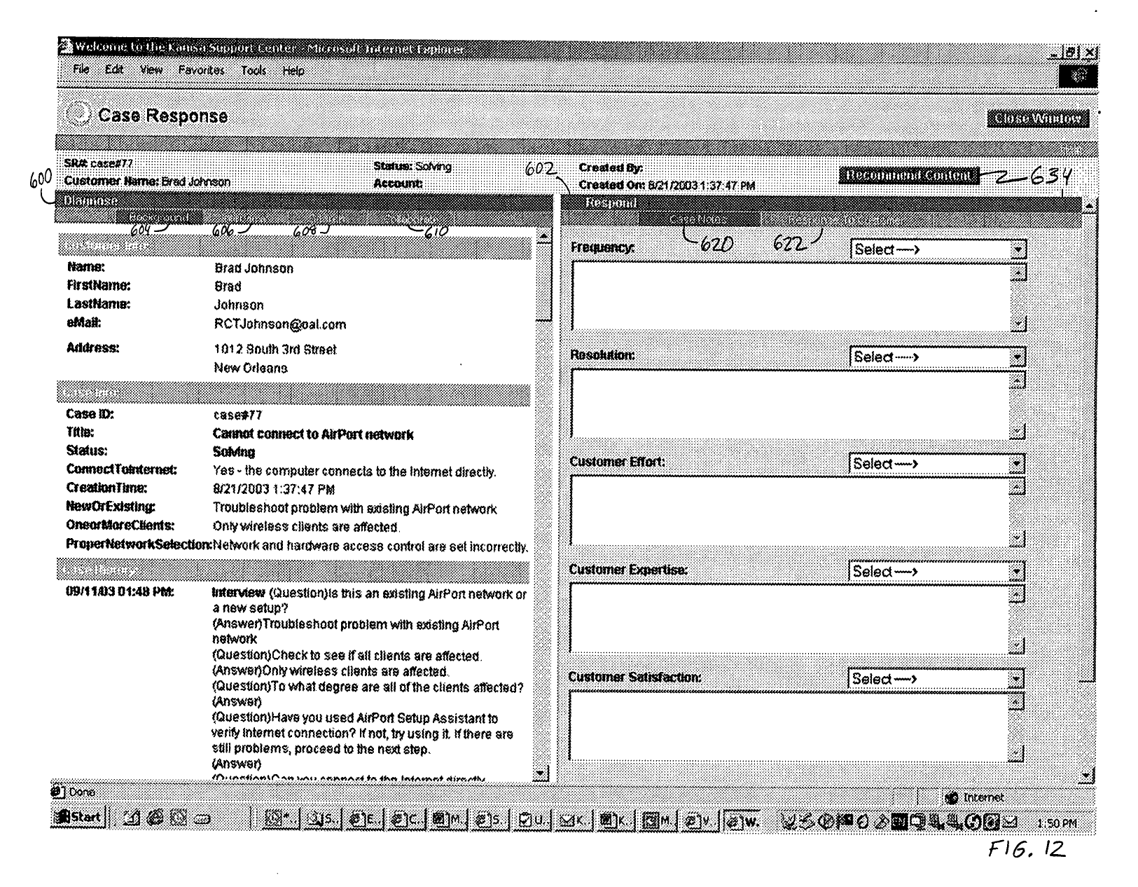

FIG. 12 is an example screenshot of the Case Response screen of FIG. 10 with the Background tab 604 activated after the interview. This displays the context accumulated thus far, including a summary of the interview questions and answers in a Case History portion of the Background screen displayed in the Diagnose window 600.

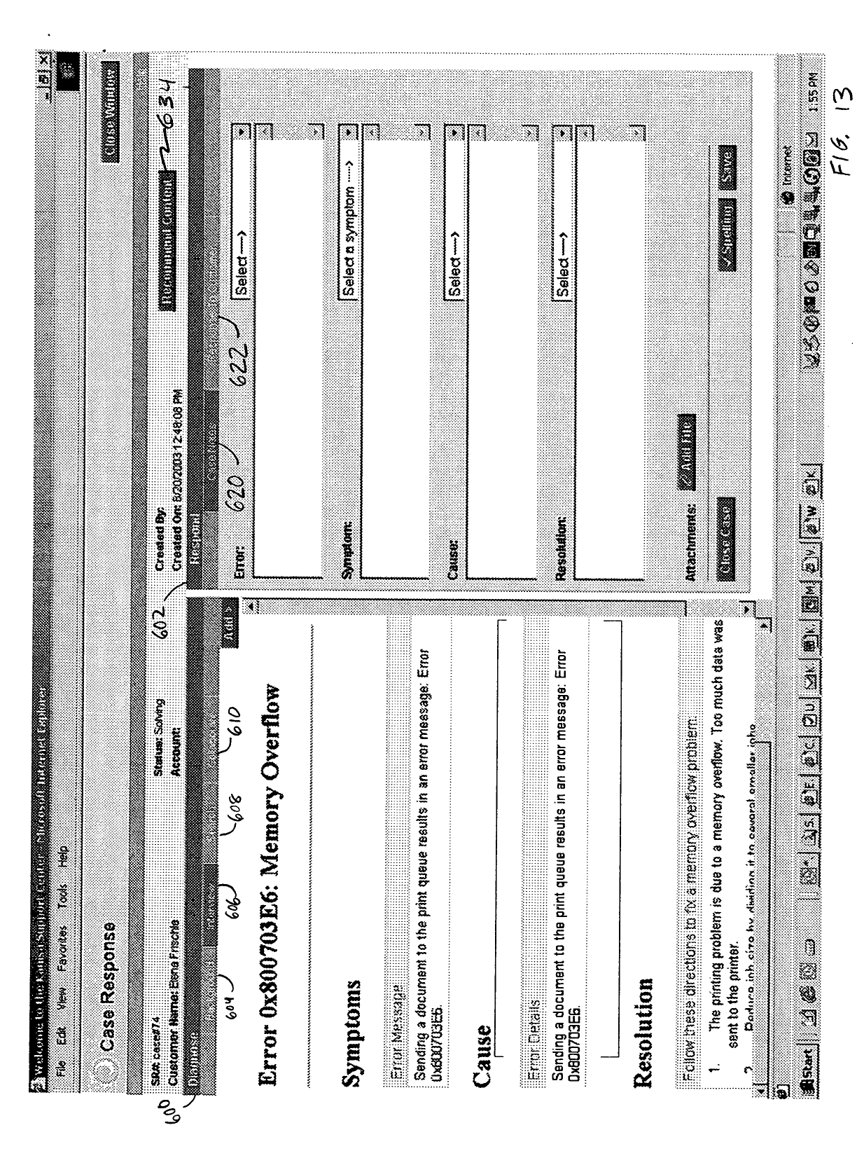

FIG. 13 is an example screenshot of a Case Response screen for a different case in which the case title or other context is a specific error message, or is otherwise specific enough to warrant directing the agent 102 to a particular “best content file,” which, in this case, is displayed in the Interview screen of the Diagnose window 600. The agent 102 can activate the “Add” button 1300 to attach the content file to the e-mail response template in the Respond window 602. In one example, the e-mail response template in the Respond window 602 is pre-populated with the appropriate textual information and the attached content file, so that the agent 102 need only send the e-mail response to the user 104.

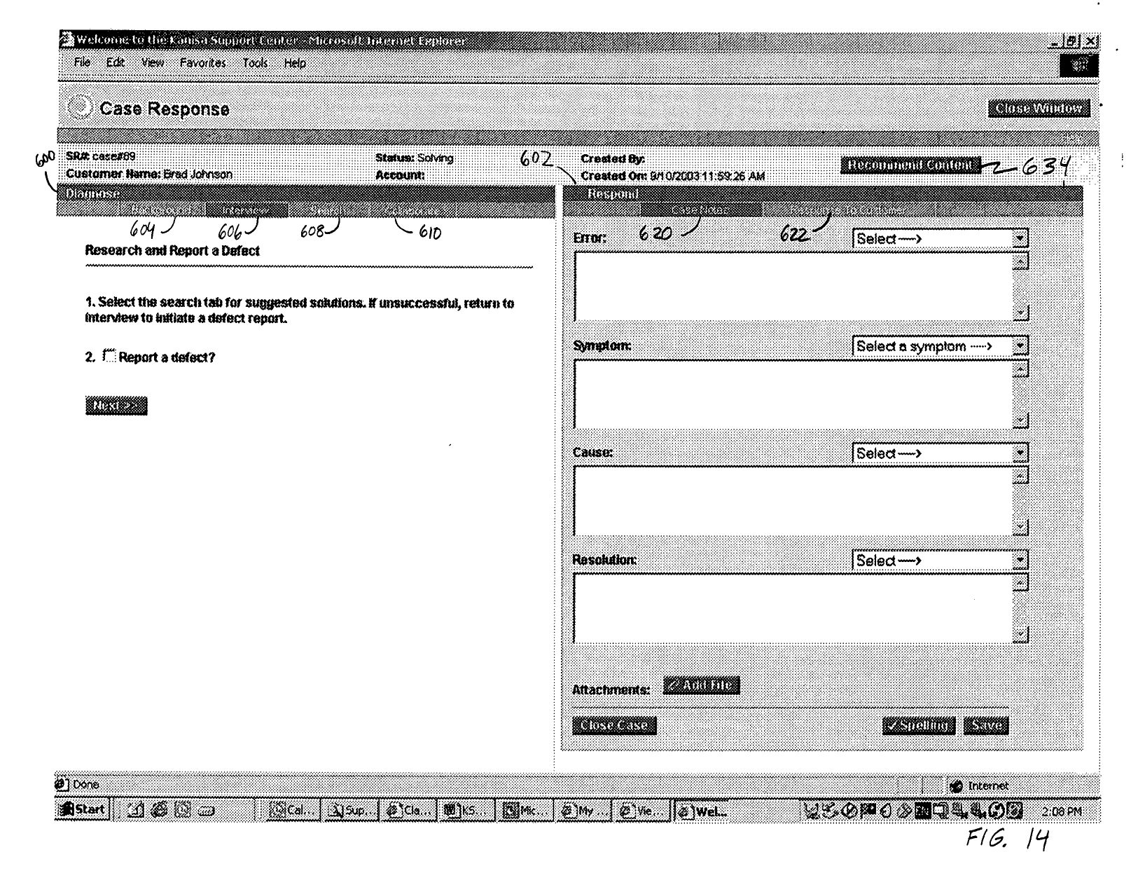

FIG. 14 is an example screenshot of a Case Response screen for a different case in which, at the end of the customized inquiry resolution process, the agent 102 is unable to resolve the customer's inquiry. In this example, this situation results activates the Interview tab 606, and initiates an interview for reporting a defect/bug. The resulting interview may ask additional questions germane to the defect/bug reporting process (e.g., “What error number is displayed?”, “What is the behavior frequency?”, “What is the severity level?”, etc.), along with providing a menu of responses for various questions. The agent 102 can then automatically (or manually) obtain a defect tracking identification number from a defect tracking system, which may be incorporated into the case tracking system 200, or may be included in a separate external system 206. In one example, the agent 102 can toggle between such a defect/bug reporting screen and other screens (e.g., search, collaborate, etc.).

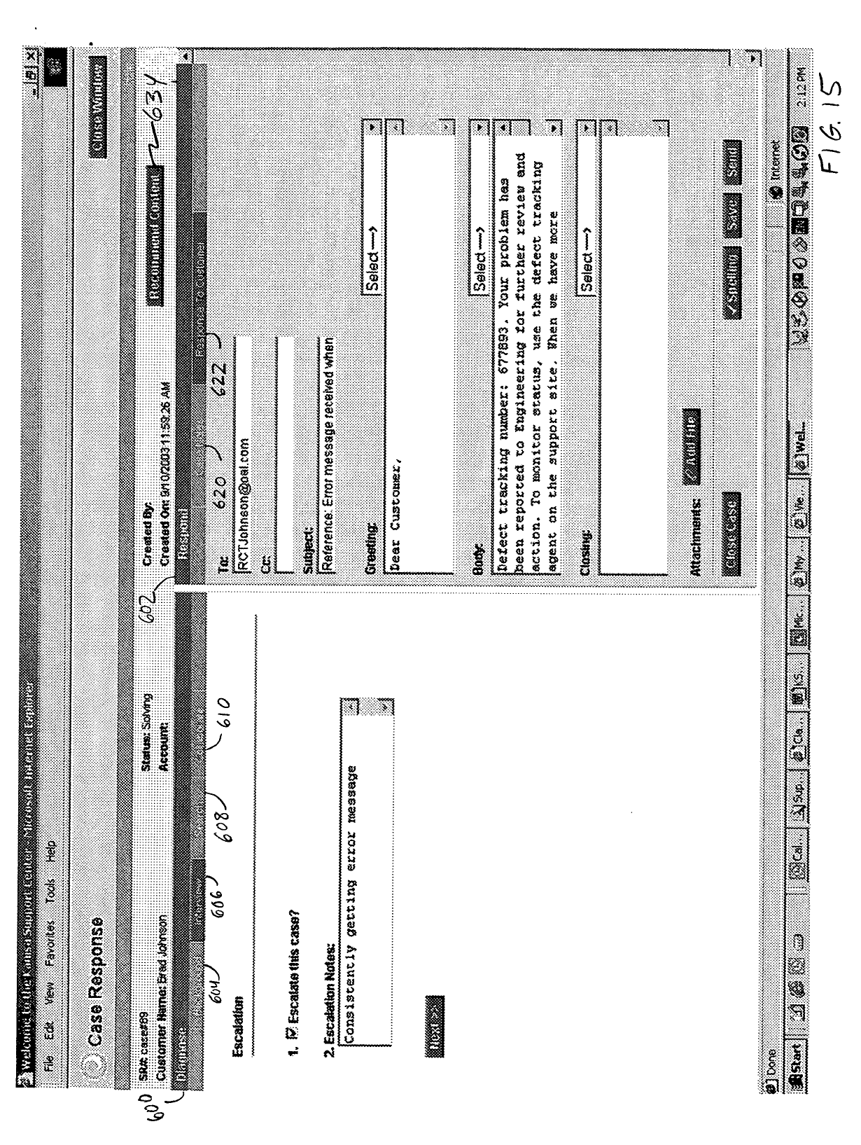

FIG. 15 is an example screenshot of a Case Response screen for the case of FIG. 14 in which the defect has been reported and the Respond window 602 is preloaded with information to be included in an e-mail response to the user 104, including the defect tracking identification number, and information for the user on how to follow up with further resolution of the customer's inquiry.

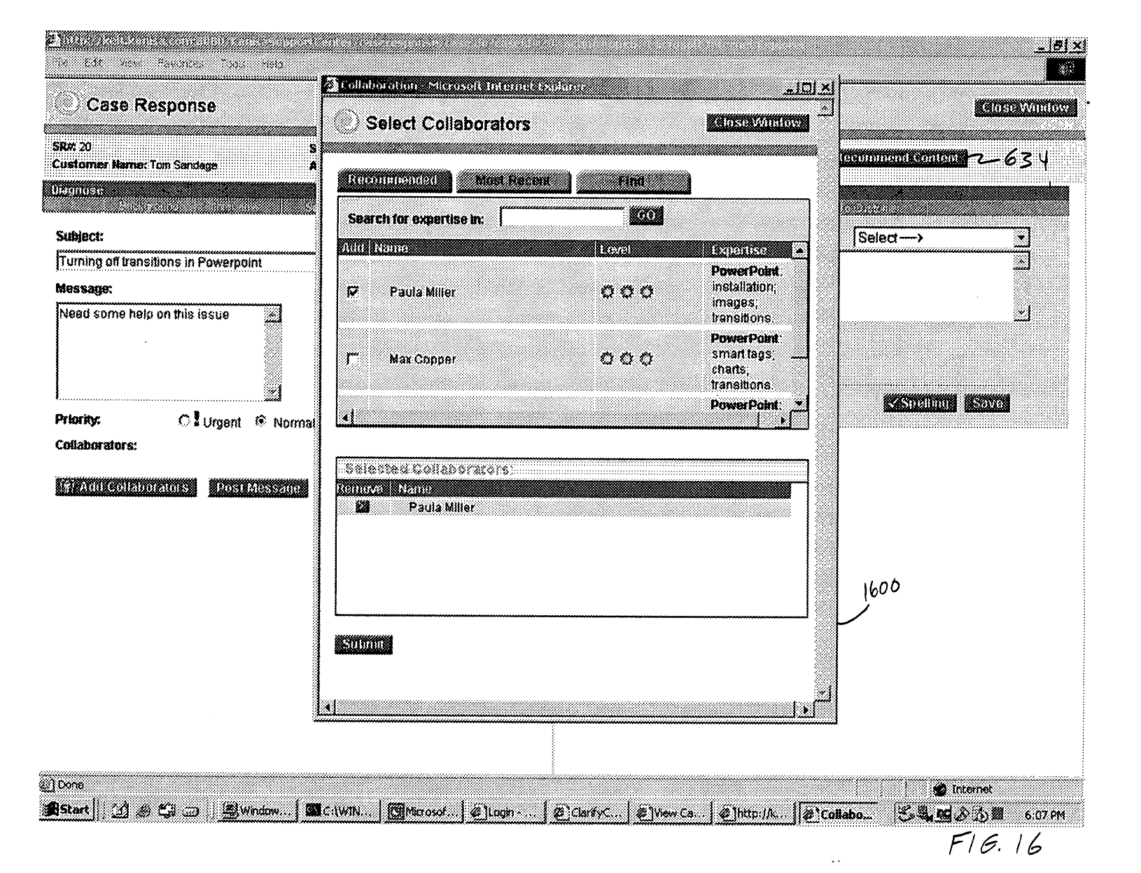

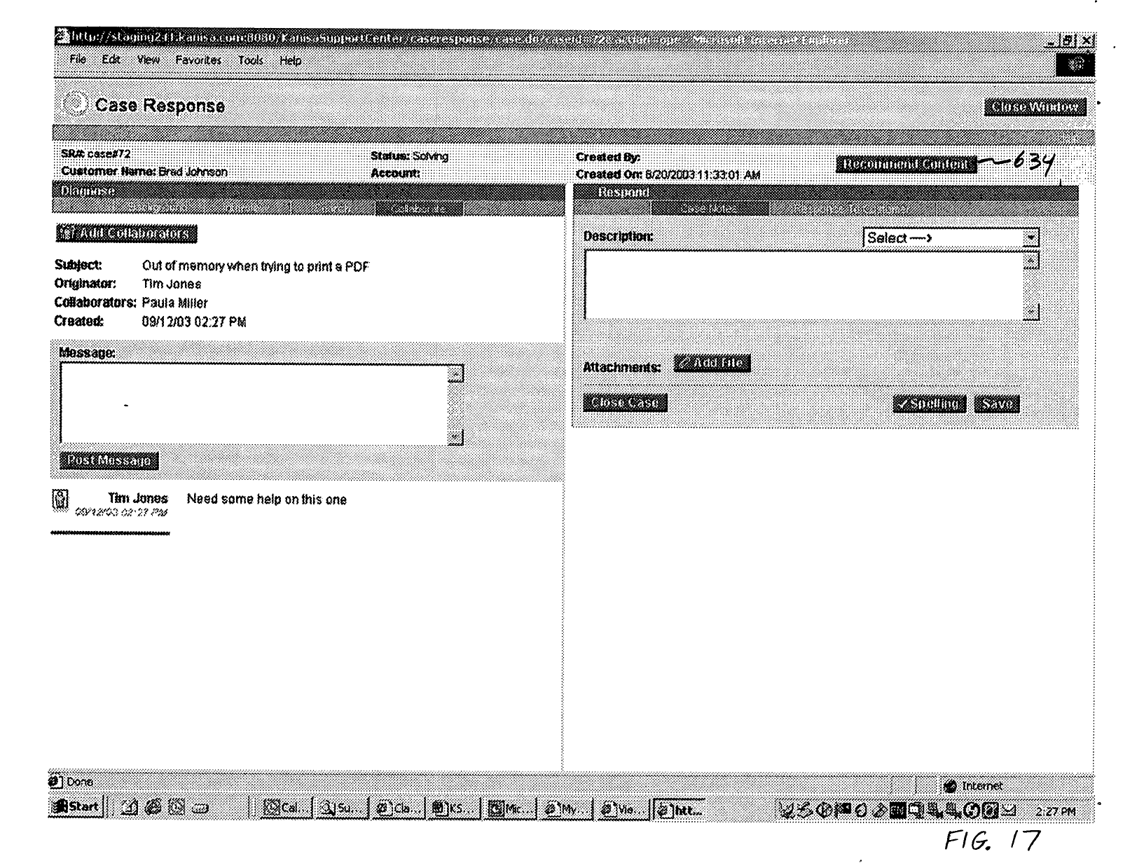

FIG. 16 is an example screenshot of a Case Response screen where the customized inquiry resolution process includes a collaboration with another. In this example, the agent 102 has selected the Collaborate tab 610, which has triggered a “Select Collaborators” screen 1600. The Select Collaborators screen allows the agent 102 to select other agents to consult with based on “Recommended” other agents, as determined by the case context, “Most Recent” other agents from previous collaboration sessions associated with the requesting agent's profile, or a “Find” of other agents using a search engine or other tool. In the Example of FIG. 16, the agent has selected a particular collaborator (e.g., “Paula Miller”). The requesting agent 102 can then post a message to the target agent 102, which, in one example, initiates a collaboration discussion thread around this case, as illustrated in the screenshot example of FIG. 17. The message then appears on the GUI 114 of the recipient agent 102, such as in a “Collaboration Inbox.” The receiving agent 102 can respond to the sending agent 102, with any content attachments, or can forward the discussion thread to other collaborating agents 102. In this way, the collaboration discussion thread can exist as long as the help is needed, and allows multiple agents 102 to work on a case together in a non-interruptive way that fits into their day. Thread responses can be captured as part of the case history and can be re-configured into new content to reduce or avoid the need for future collaborations between agents.

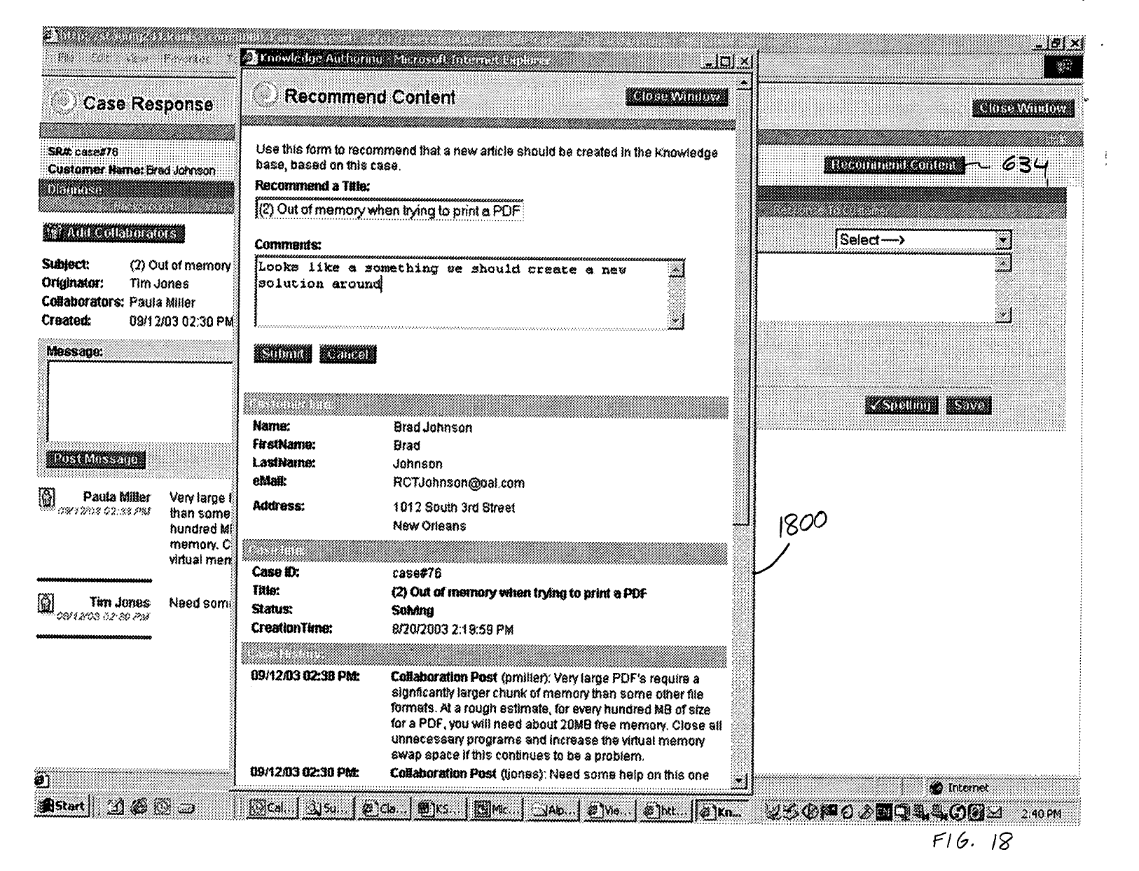

FIG. 18 is an example screenshot illustrating operation in response to activating the “Recommend Content” button 634 on the Case Response screen. An agent 102 may desire to recommend that content be added when the agent could not resolve the customer inquiry, or could not do so without collaborating with another agent 102. When the Recommend Content button 634 is activated, a Recommend Content screen 1800 is displayed. The agent 102 can submit the context accumulated thus far in the case, along with any additional comments, to the system 100. This will be logged. A knowledge engineer can use this information to determine whether additional content should be created, or whether the process of steering the agent toward the needed content should be modified.

7. System Administration Tools Examples

FIGS. 6-18 have illustrated various Case Response screens that are displayed in response to a “Resolve” command from a CRM or other case tracking system, such as illustrated in FIGS. 4 and 5. System 100 also includes various administrative tools. For example, system 100 includes one or more web pages displayed on GUI 114 for controlling the automatic configuring the customized inquiry resolution process. In this administrative mode, the GUI 114 permits a system administrator to specify at least one of: (1) which customer inquiry resolution options (e.g., search, interview, directed content file, etc.) make up a particular customer inquiry resolution process; (2) a sequence of using these options; (3) which content for at least one of these options is to be used; and (4) which context attribute(s) are to be instantiated into at least one of the options.

In the administrative mode, the GUI 114 further provides one or more editors for creating and/or editing: interview scripts, templates for responses to users 104, templates for responses to a case tracking system 100 or another computerized system 206, content, attributes for introducing context into content. The GUI 114 also maps between context and customized user inquiry resolution processes.

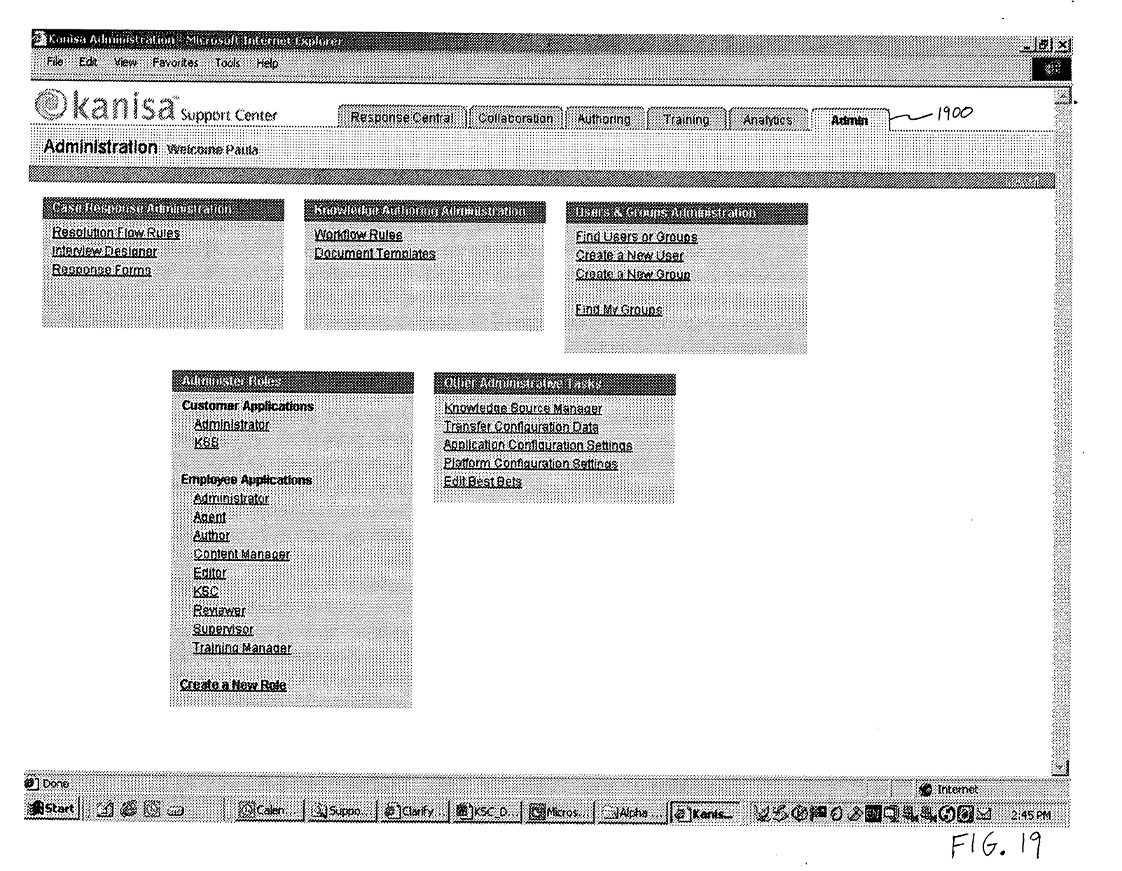

FIG. 19 is an example screenshot of an “Admin” web browser screen 1900 displayed on the GUI 114. It includes links to various system administration type functions, such as “Case Response Administration,” “Knowledge Authoring Administration,” “Users & Group Administration,” “Administration Roles,” and “Other Administrative Tasks.” In this example, the “Case Response Administration” includes a link to a “Resolution Flow Rules” module to configure operation of the rules engine 204, an “Interview Designer” module to design scripts for different types of interviews by agents 102 of users 104, and a “Response Forms” module to create templates for responding to the user 104, the case tracking system 200, or another system 206, in an appropriate manner.

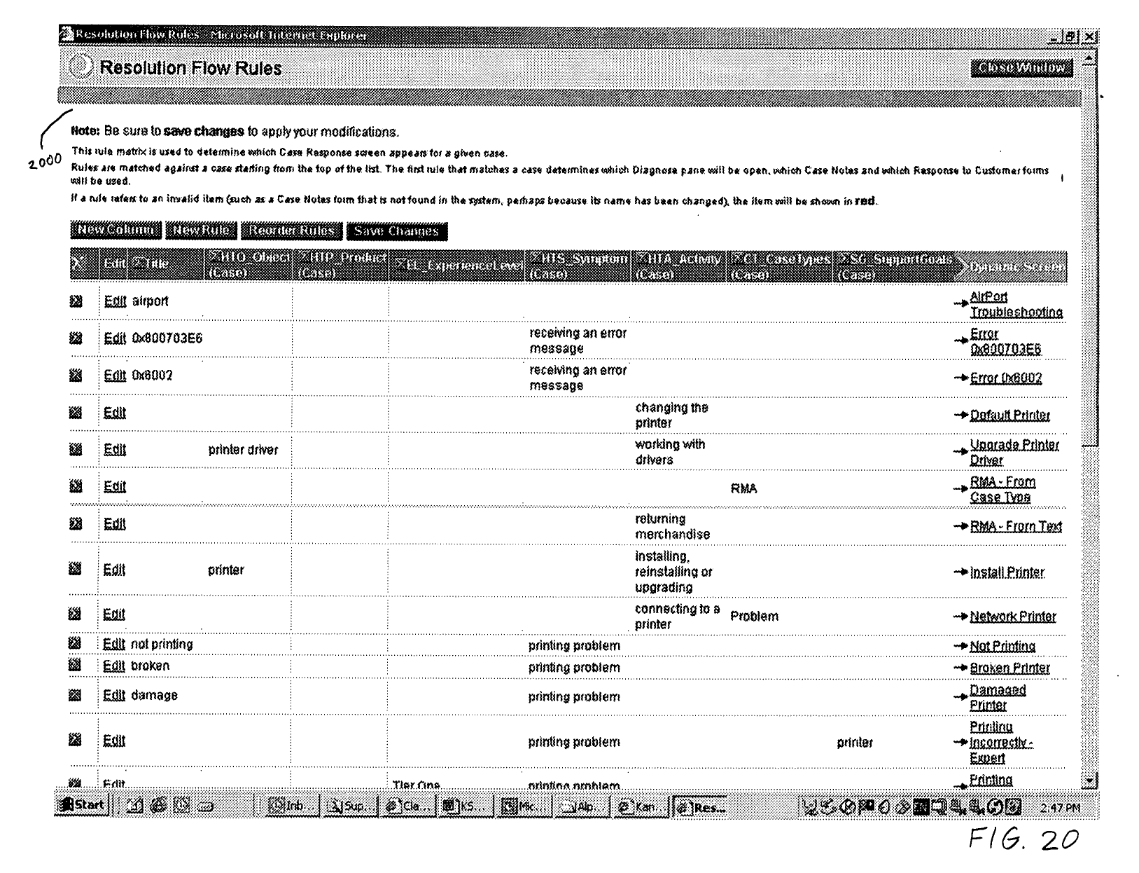

FIG. 20 is an example screenshot of a “Resolution Flow Rules” web browser page 2000 that includes matrix of rows and columns. Each row represents a condition set that maps to a particular customized inquiry resolution process, which is also referred to herein as a “Dynamic Screen,” as indicated in the right-hand column of the matrix. That is, a “Dynamic Screen” refers to how a customized inquiry resolution process is displayed on a GUI display screen. It is dynamic because the screen includes different windows, sub-screens, or other such devices that embody the different actions in the customized inquiry resolution process that are made available for use by the agent 102. The other column titles represent various context parameter fields. The information within various cells each represents a condition upon the context parameter field of the column in which it appears. If the context of a particular case matches the information in the cell, then the condition for that particular column is met. Empty cells indicate that no particular condition is imposed upon the context parameter field heading that column. If all of the conditions in a particular row are met, then that row's particular customized inquiry resolution process is served as a Dynamic Screen to the agent 102. The condition set rows are tested in the order in which they appear, from top to bottom, in FIG. 20. The bottom-most row is a default customized inquiry resolution process that is served as a dynamic screen to the agent 102 if no other condition sets have been met for the context of a particular case being resolved.

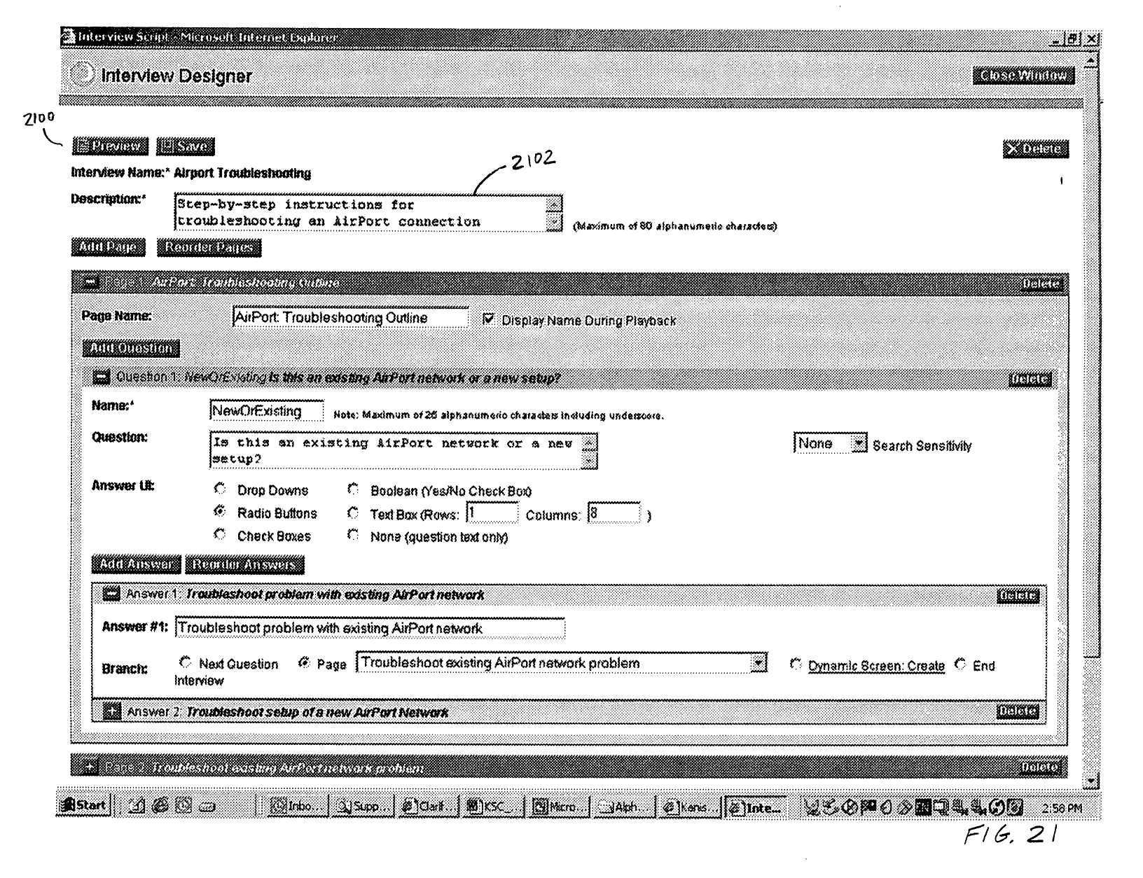

FIG. 21 is an example screenshot of an “Interview Designer” web browser page 2100 that provides a GUI for designing scripts for interviews by agents 102 of users 104 to assist in resolving customer inquiries. It includes a script description form 2102, and windows for adding questions, menus of answers, and branch points in the interview.

8. Financial Services Example

Although FIGS. 4-21 primarily exemplified customer inquiries regarding goods or services in the high technology field, the system 100 is not so limited. In another example, the case tracking system 200 is a client management database system used in the financial services industry, as illustrated in the example screenshot of FIG. 21.

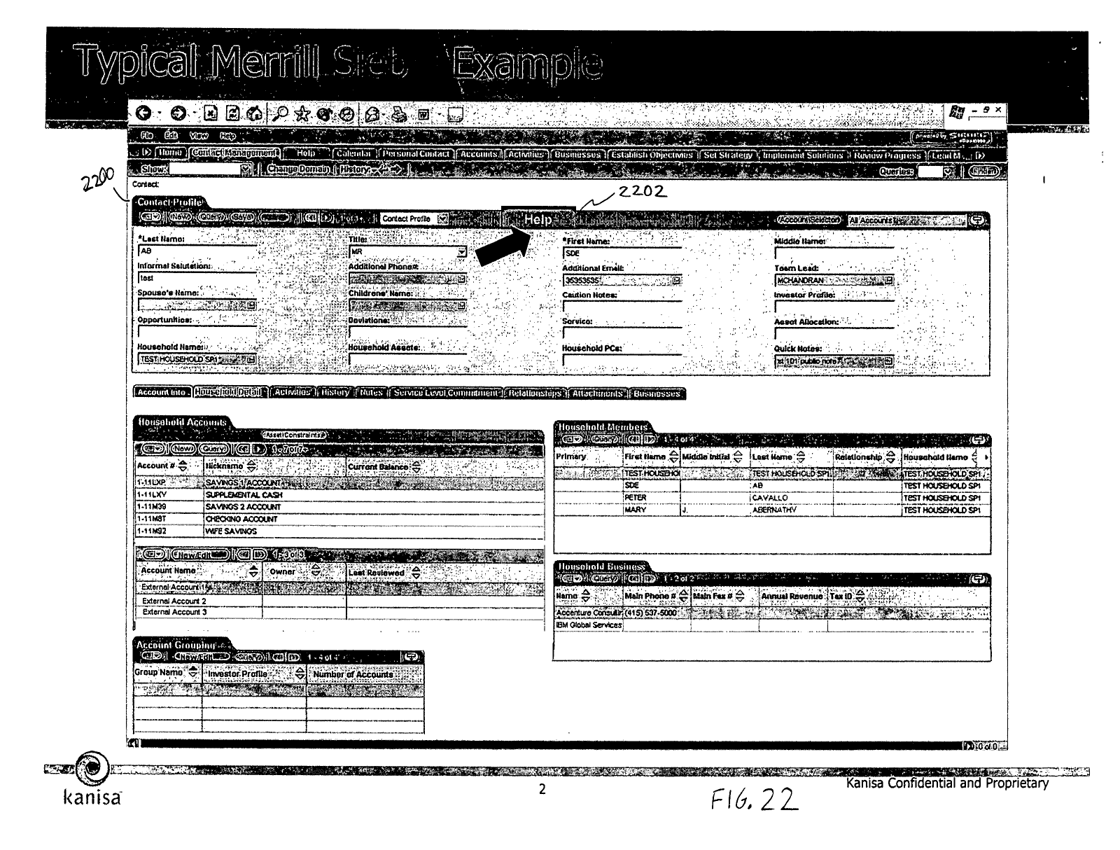

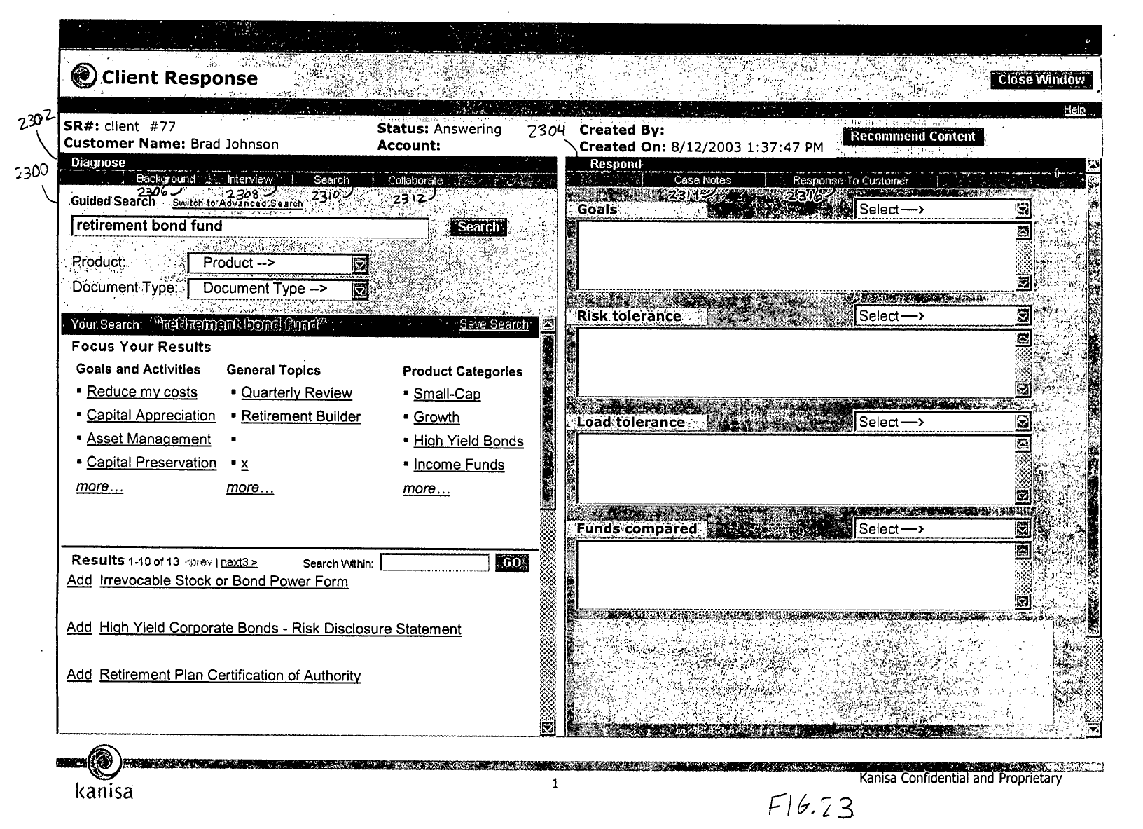

FIG. 22 illustrates an example screenshot of a Contact Management screen 2200 of the database display on the GUI 114. This screen includes a Help button 2202 that calls the system 100 with context. In response, system 100 uses the received context to trigger display of a Client Response dynamic screen 2200 on GUI 114, as illustrated in the example screenshot of FIG. 23. The Client Response screen 2300 includes a Diagnose window 2302 and a Respond window 2304. Different options in a customized inquiry resolution process are illustrated by a Background tab 2306, an Interview tab 2308, a Search tab 2310, a Collaborate tab 2312, a Case Notes tab 2314, and a Response to Customer tab 2316. In the example of FIG. 23, the Search tab 2310 is active to provide a guided search that is pre-loaded with search terms using context received from the financial services database system 200. The guided search may include filters or links for focusing or expanding the search results. In the example of FIG. 23, these links are organized into “Goals and Activities,” “General Topics,” and “Product Categories,” groups, instead of the “Activity,” “Objects,” “Product,” “Symptom,” groups describe with respect to the earlier examples. FIG. 23 also illustrates links to various content files returned by the guided search. The Respond window 2304 includes, in this example, “Goals,” “Risk Tolerance,” “Load Tolerance,” and “Funds compared” windows. The particular windows that are selected for display within the Respond window 2304 are selected using the context.

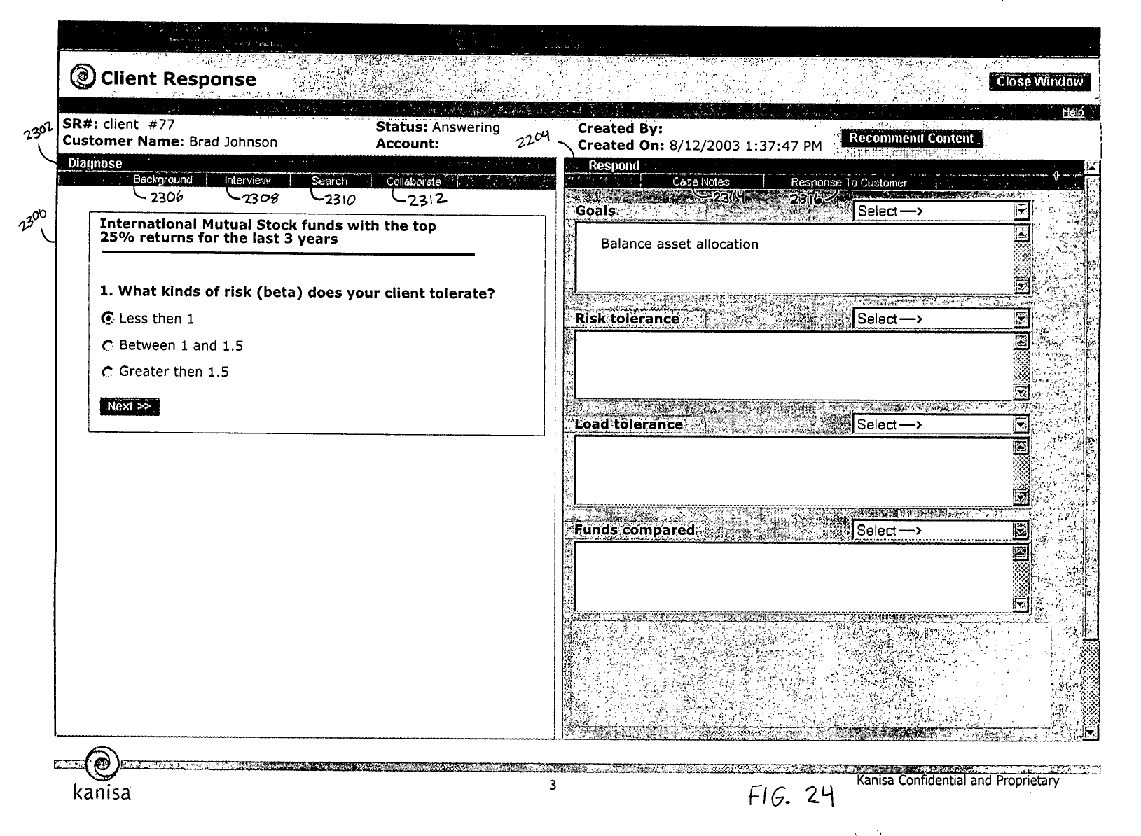

FIG. 24 is an example screenshot that illustrates an interview portion of the customized inquiry resolution process, with context (e.g., “Balance asset allocation”) entered into the Respond window 2304, such as by the agent 102, thereby creating additional context.

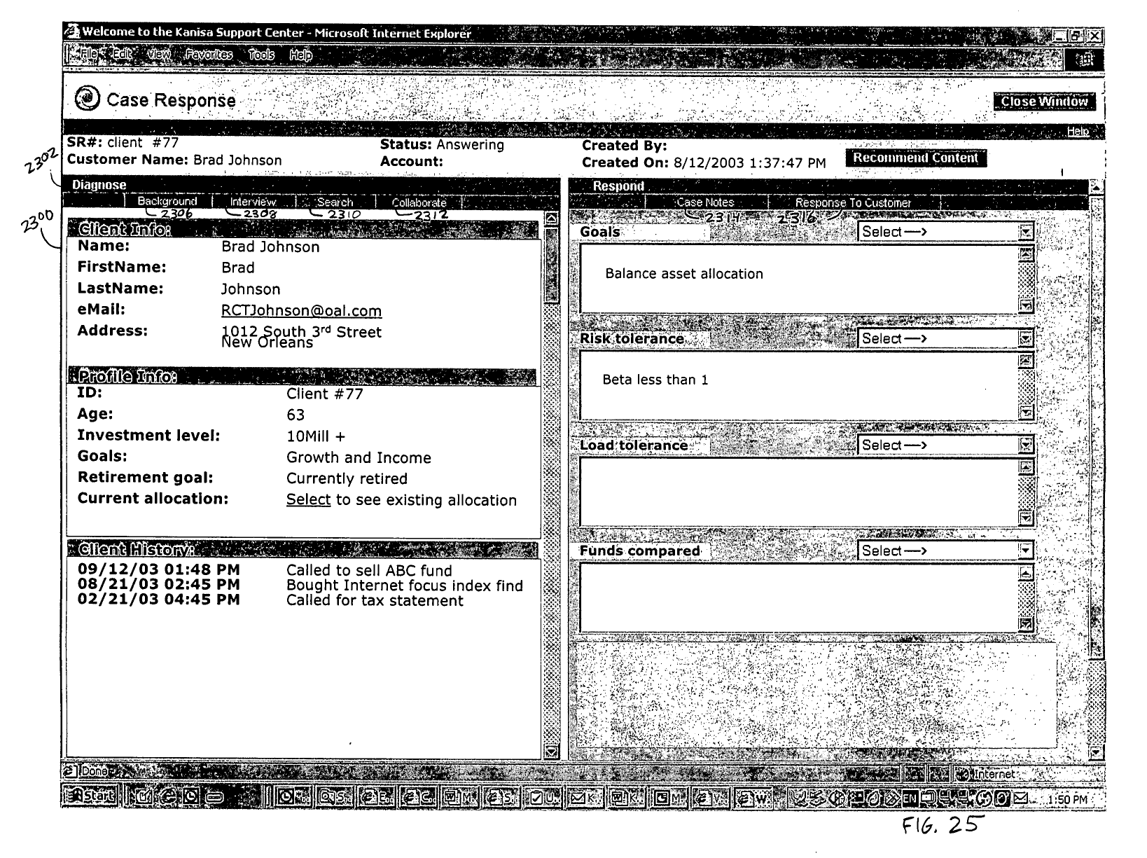

FIG. 25 is an example screenshot that illustrates a Background portion of the customized inquiry resolution process, which displays context in the Diagnose window 2302, including client information, client profile information, and client history information about previous contacts with the user 104. Context that is created during the interview is automatically entered by the system 100 into the appropriate Case Notes window of the Respond window 2304 of FIG. 25.

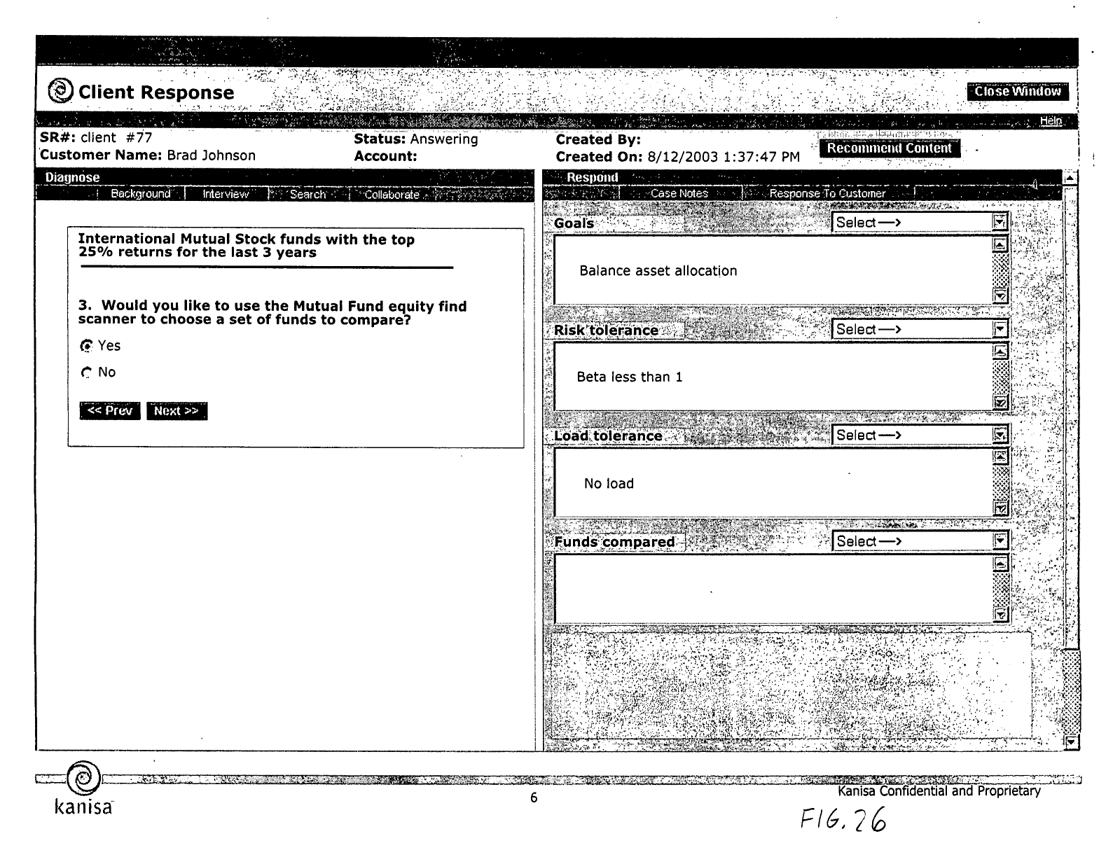

FIG. 26 is an example screenshot that illustrates an interview branch point that, based on the response to the interview question, initiates a call to another application (e.g., a Mutual Fund equity fund scanner, in this example).

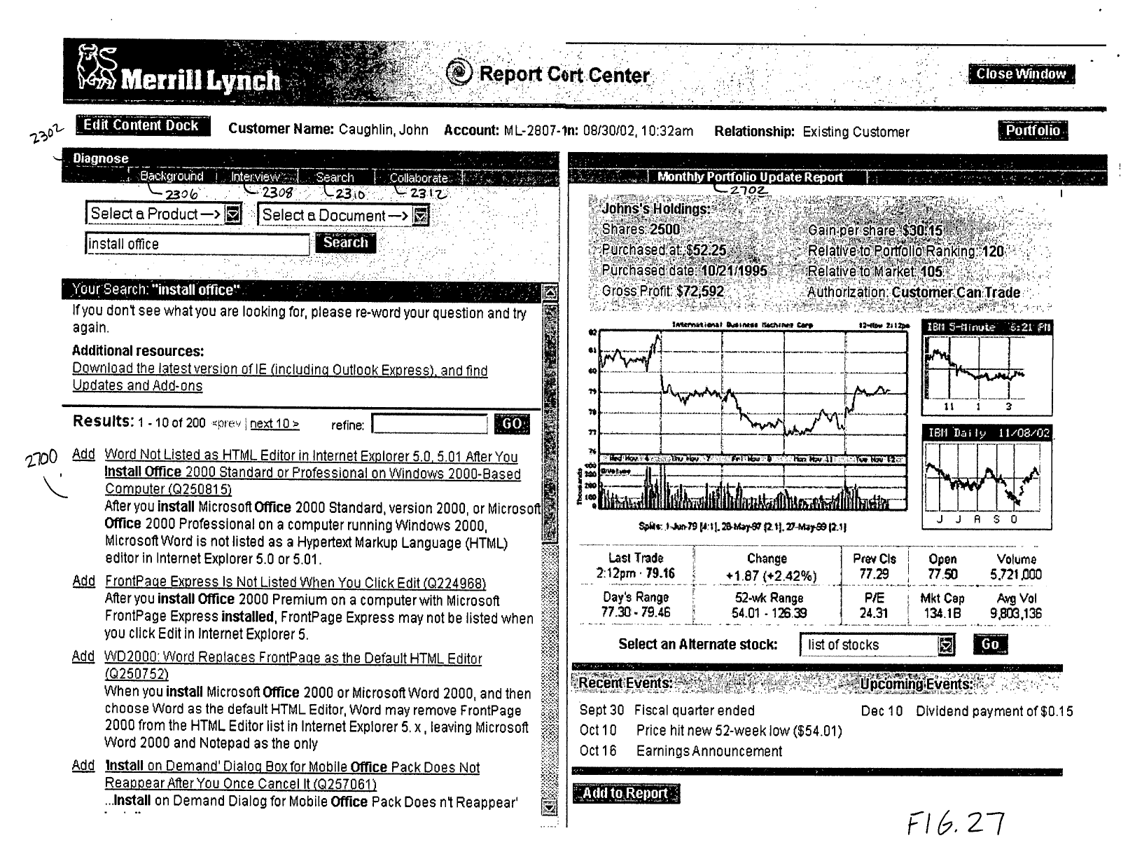

FIG. 27 is an example screenshot that illustrates a dynamic screen 2700 representing a somewhat different customized inquiry resolution process. In this example, the Respond window includes tab 2702 for a Monthly Portfolio Update report as part of the customized inquiry resolution process as determined from the context received from the system 200 or created thereafter. The resulting portfolio report, which is personalized for the user 104, can be viewed by the agent 102 or sent to the user 104.

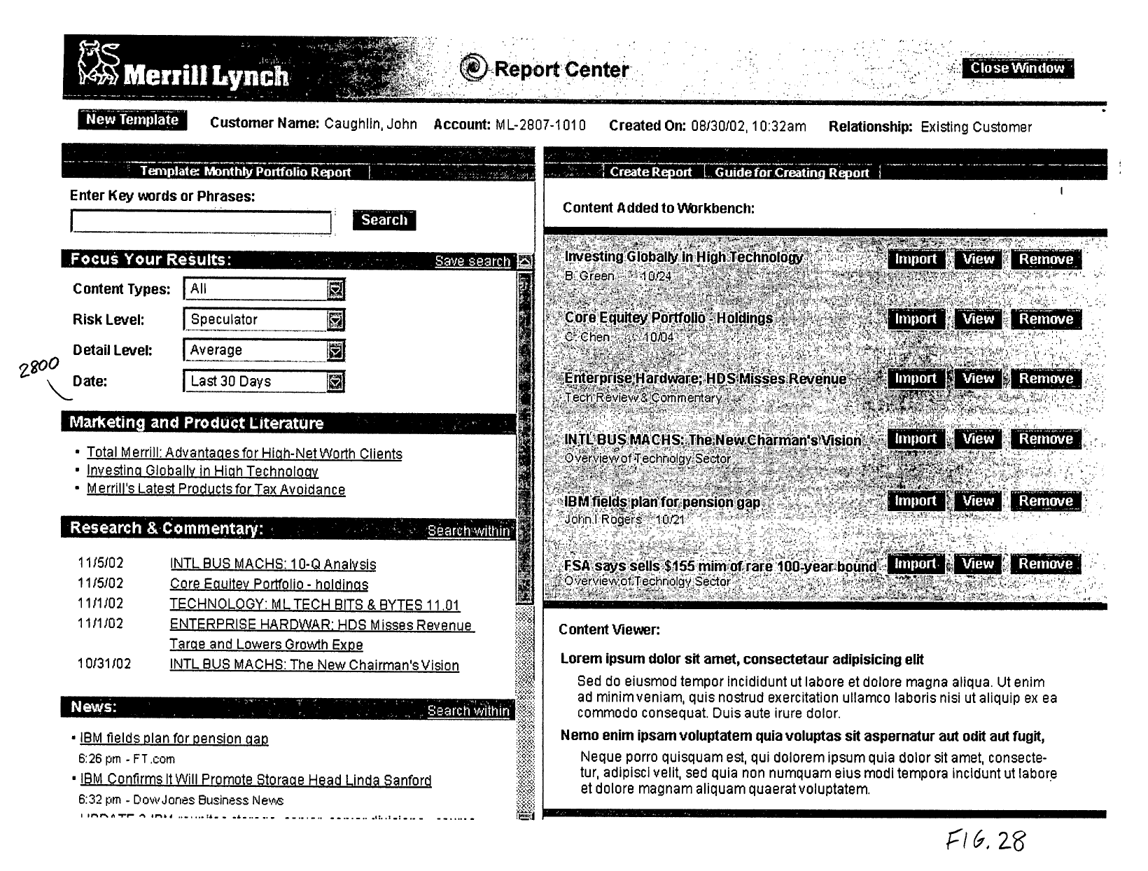

FIG. 28 is an example screenshot that illustrates a dynamic screen 2800 representing yet another customized inquiry resolution process, which includes a guided search on the left hand side of the screen 2800. The right hand side of the screen 2800 includes research reports or other content files that can be added by the agent 102 to the customized portfolio report of FIG. 27 for delivery to the user 104.

9. Other Examples

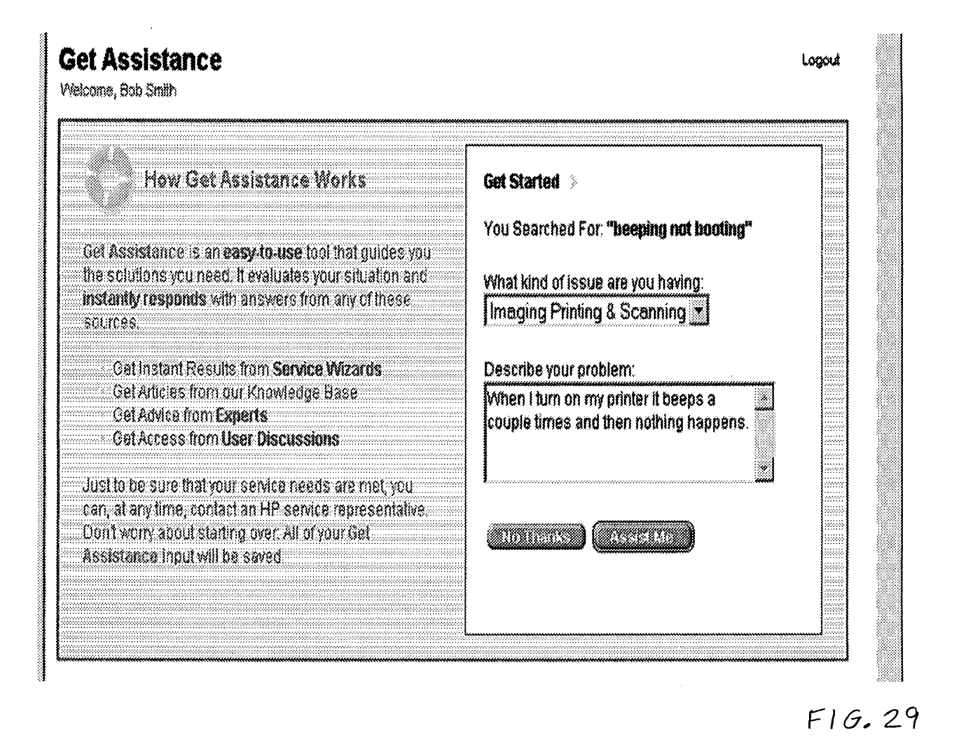

FIGS. 29-33 are example screenshots of an alternative dynamic screen representing a customized inquiry resolution process. In this example, the customer inquiry need not originate from a CRM or other case tracking system. For example, the customer inquiry may originate with the user 104 using a web page or other online help center, thereby generating context that is received by the system 100. In this example, some of the steps of the customized inquiry resolution process are performed by the user 104, without assistance from an agent 102 until such assistance is actually needed.

FIG. 29 is an example screenshot of an initial online web page for receiving a customer inquiry. This example includes a web form that is configured to receive natural language textual input from the user 104. This example also includes a menu that allows the user 104 to select one of a set of predefined categories for describing the customer's inquiry. This information is provided to the system 100 as context that initiates a customized inquiry resolution process.

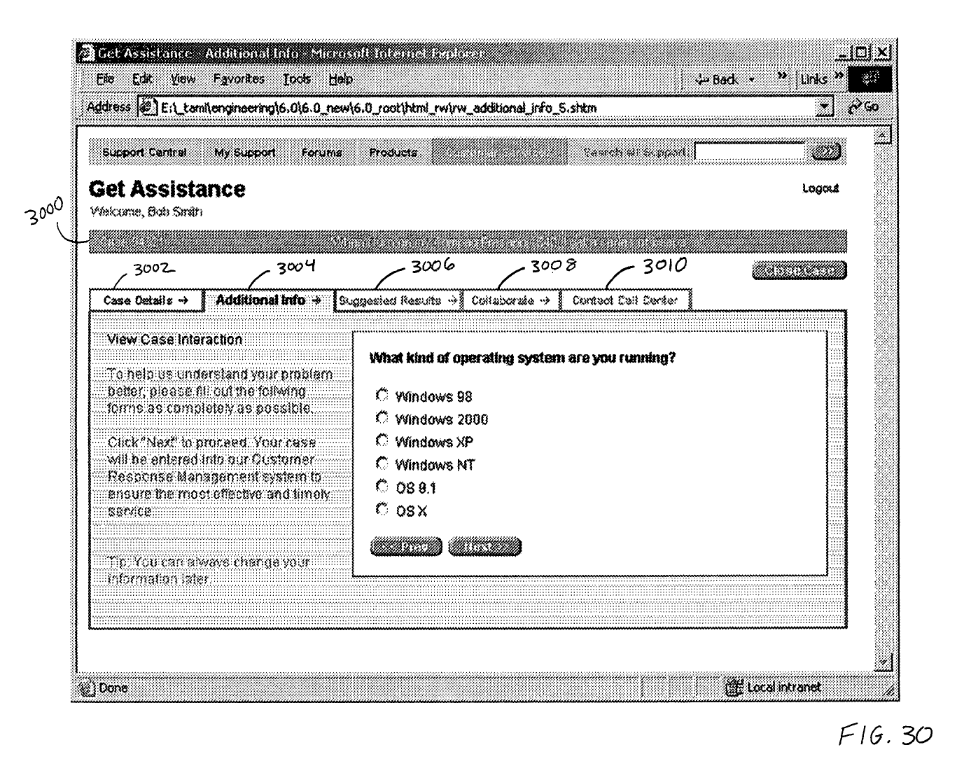

FIG. 30 is an example screenshot of a resulting dynamic screen for displaying the customized inquiry resolution process created by the system 100 in response to the received context. In FIG. 30, a case number 3000 has been created.

The customized inquiry resolution options are represented by a “Case Details” tab 3002, an “Additional Info” tab 3004, a “Suggested Results” tab 3006, a “Collaborate” tab 3008, and a “Contact Call Center” tab 3010. In this example, these tabs are presented in the sequence in which they are to be used by the user 104 or agent 102. The “Case Details” tab 3002 corresponds to the screen illustrated in FIG. 29. In FIG. 30, the “Additional Info” tab 3004 is active. As seen in FIG. 30, this includes an automated interview wizard or the like for receiving additional information from the user 104. In this example, the particular interview is customized using the previously accumulated context.

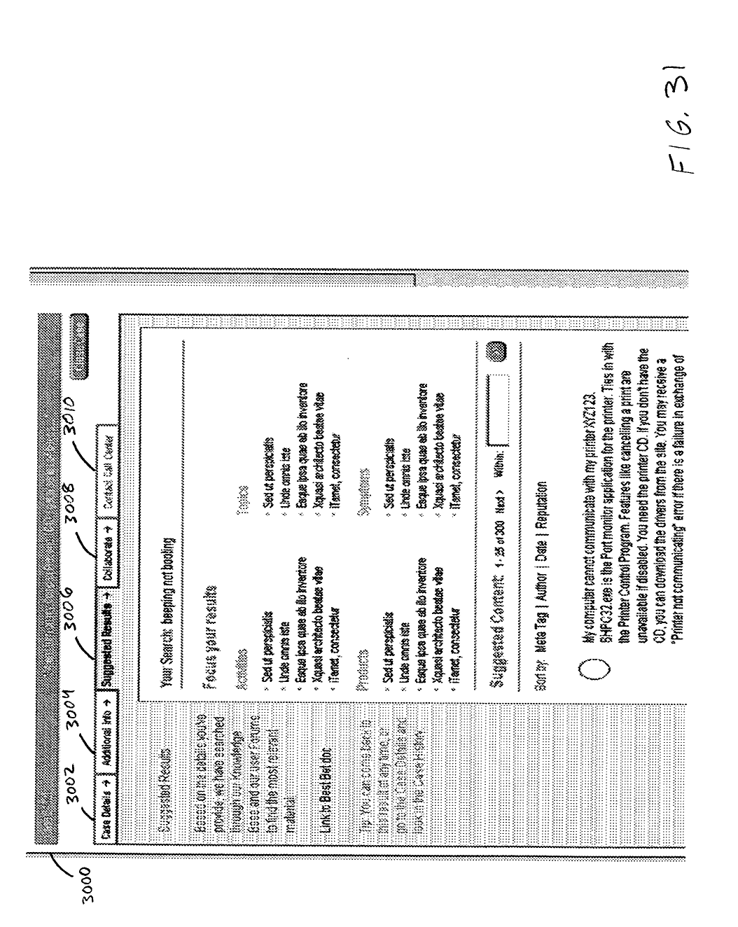

FIG. 31 is an example screenshot of the dynamic screen in which the Suggested Results tab 3006 is active. This step in the customized inquiry resolution process performs and displays a guided search using the previously accumulated context.

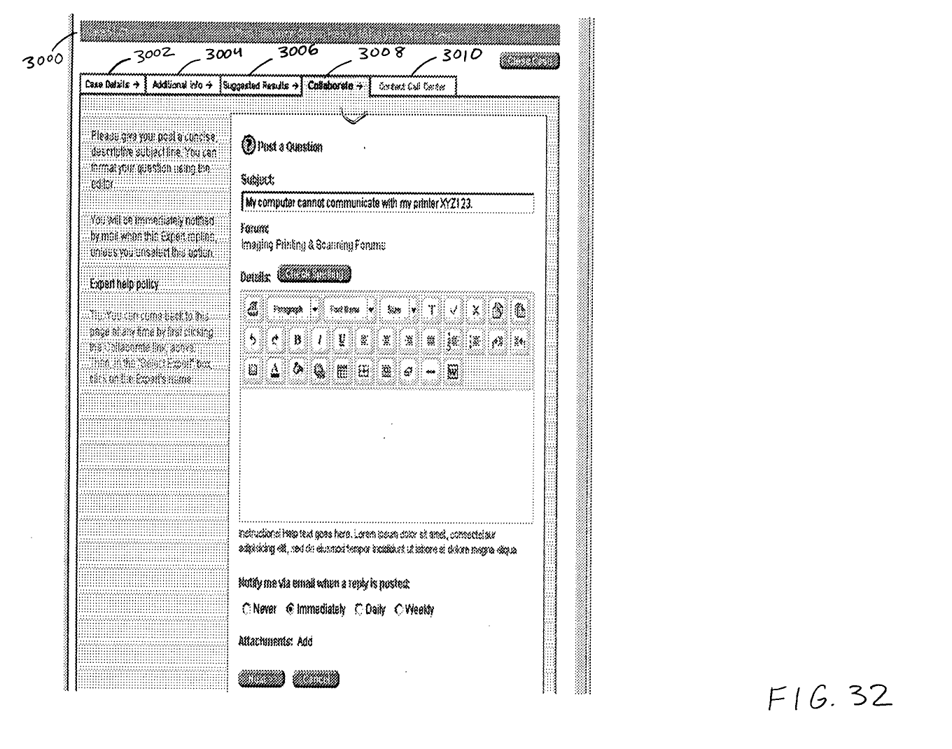

FIG. 32 is an example screenshot of the dynamic screen in which the Collaborate tab 3008 is active. This step in the customized inquiry resolution process allows the user 104 to post their question to an online expert or forum, such as by creating a discussion thread. The particular expert or forum may be selected using the context.

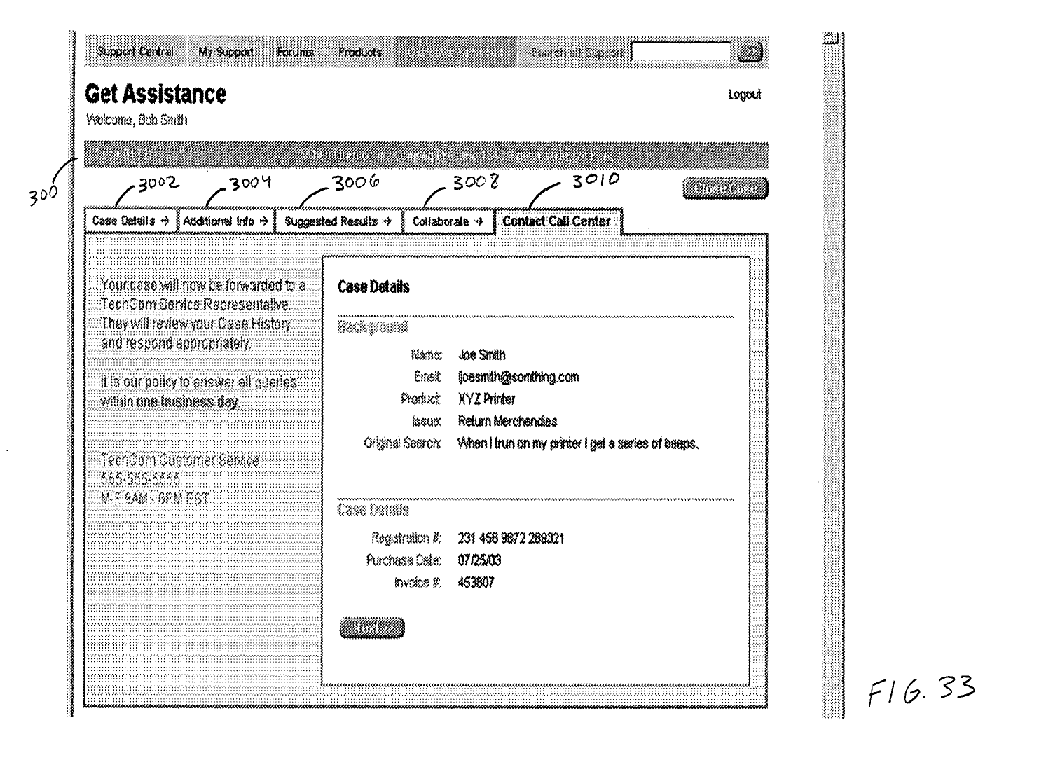

FIG. 33 is an example screenshot of the dynamic screen in which the Contact Call Center tab 3010 is active. This “escalation” step in the customized inquiry resolution process, if needed, allows the user 104 to contact a customer service call center to obtain further assistance from a live agent 102.

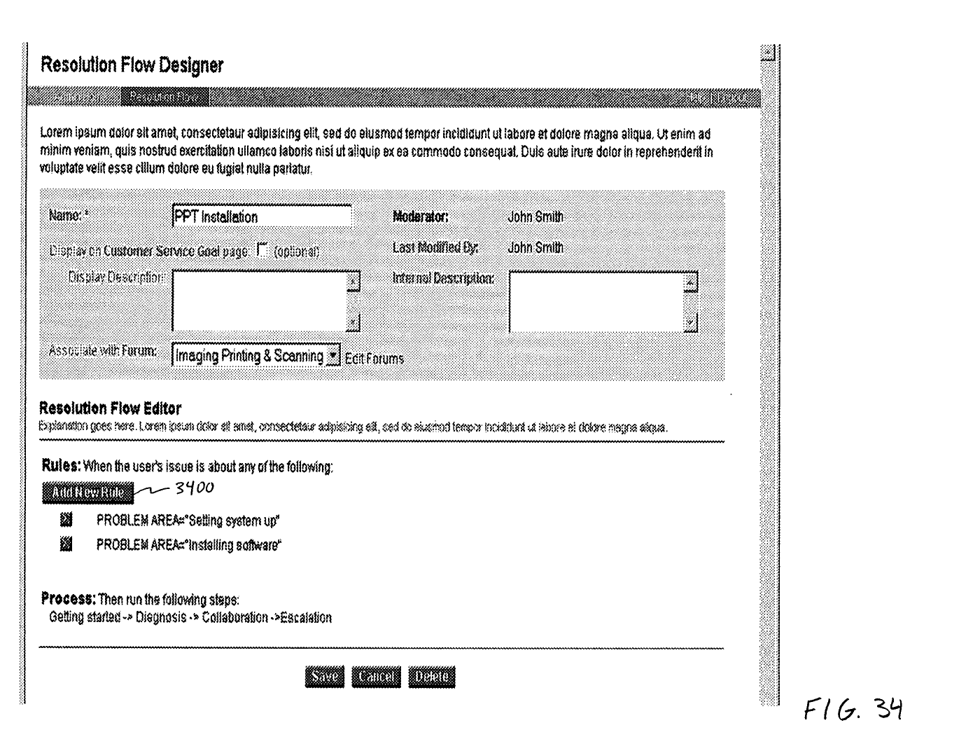

FIGS. 34-36 are example screenshots of an administrative user interface for creating rules or condition sets and defining corresponding customized inquiry resolution processes to be provided in response to the rule or condition set being satisfied by the context associated with a particular customer inquiry.

FIG. 34 is an example screenshot of an administrative graphical user interface for creating customized inquiry resolution processes and corresponding condition sets for triggering the same. It includes an “Add New Rule” button 3400 for displaying a screen to assist an administrator in creating a new rule.

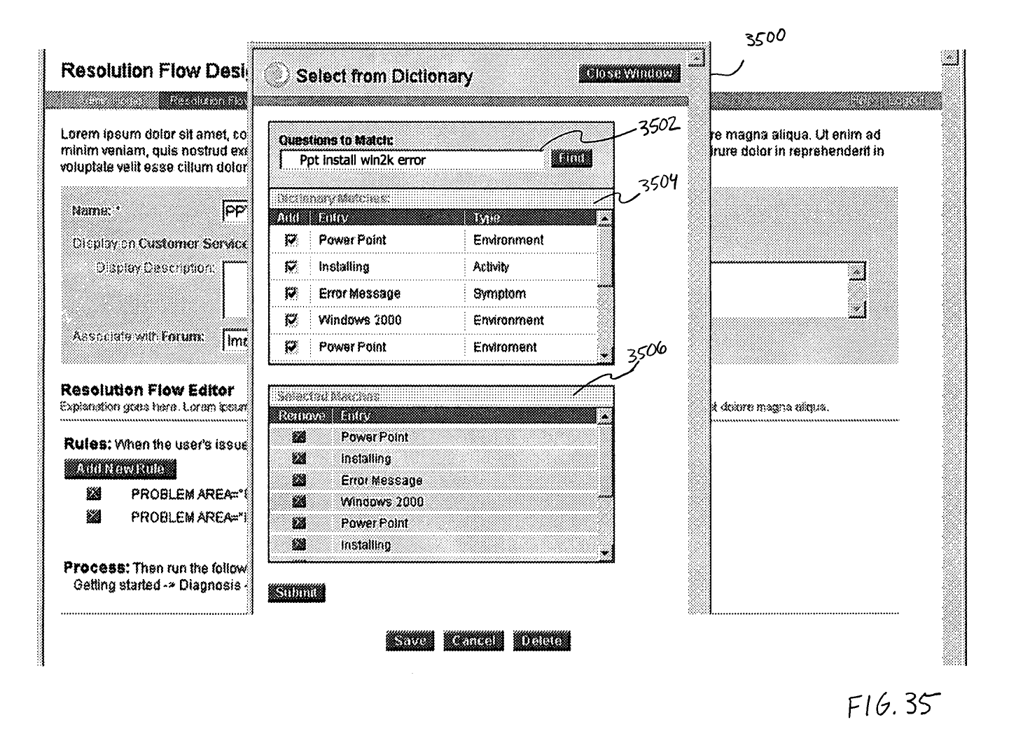

FIG. 35 is an example screenshot of a resulting “Select from Dictionary” screen 3500 that is displayed in response to the administrator activating the Add New Rule button 3400. The screen 3500 includes a form 3502 that accepts natural language input and searches for applicable concept nodes in a knowledge map (wherein the knowledge map includes content that is mapped to such concept nodes) to use in the rule or condition set being created. The screen 3500 includes a “Dictionary Matches” window 3504 that suggests potential concept nodes in the knowledge map that are possibly relevant to the rule or condition being created. The screen 3500 also includes a “Selected Matches” window 3506 for choosing which ones of the suggested concept nodes are to be used in the rule or condition being created. Suitable examples of knowledge maps and concept nodes are discussed in the above-incorporated Copperman et al. U.S. patent application Ser. No. 10/047,446.

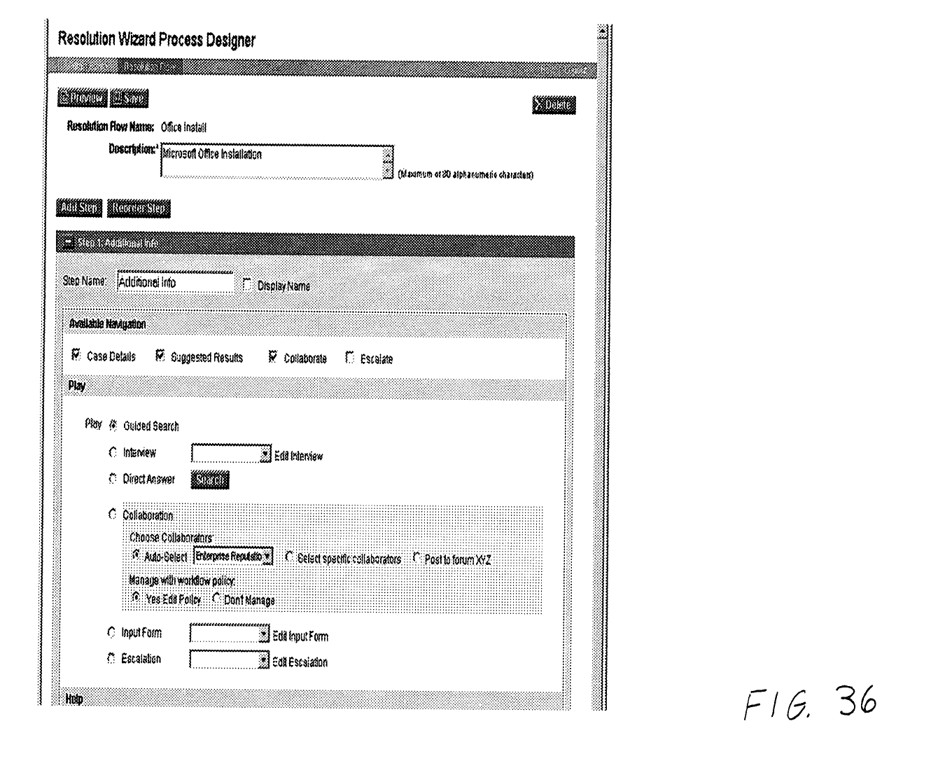

FIG. 36 is an example screenshot of a subsequent form for defining the customized inquiry resolution process corresponding to the rule or condition set being created. It allows the administrator to define which steps should be included in the customized inquiry resolution process, and the sequence of performing the same. It also lets the administrator to define which tools or items (e.g., search engine, script player, etc.) correspond to the particular steps in the customized inquiry resolution process being defined. It further allows the administrator to define which content (e.g., a particular script or scripts, a particular document, etc.) correspond to the particular tools or items that are used in the customized inquiry resolution process.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects.

1. A computer-implemented system comprising:
a knowledge engine, using context relevant to a user inquiry in automatically configuring a customized inquiry resolution process that is particular to the user inquiry, the customized inquiry resolution process including using the context for choosing at least two items selected from:
(1) a search engine that performs a search using the context;
(2) a script player to assist a customer service agent to conduct an interview;
(3) a collaborative or escalative session for the customer service agent with another customer service agent;
(4) a response template to respond to the user;
(5) a response template to respond to an external computerized case tracking system;
(6) a response template to respond to an external computerized system;
(7) a display of at least one content file; and
(8) an interaction with another computerized system.

2. The system of claim 1, in which the choosing at least two of the items includes matching at least one (attribute, value) pair of the context associated with a particular customer inquiry against at least one predetermined condition that is associated with a particular customized inquiry resolution process.

3. The system of claim 1, in which the automatically configuring the customized inquiry resolution process includes using the context for choosing a sequence in which the customer service agent uses the chosen at least two items.

4. The system of claim 1, in which the automatically configuring the customized inquiry resolution process includes choosing content, using the context, for at least one of the chosen at least two items.

5. The system of claim 1, in which the automatically configuring the customized inquiry resolution process includes inserting at least some of the context into content for at least one of the chosen at least two items.

6. The system of claim 1, further including using the context for customizing at least one of the at least two chosen items.

7. The system of claim 1, further comprising a graphical user interface (GUI) configured for specifying the customized inquiry resolution process by defining which items comprise the chosen at least two items if a condition set is met.

8. The system of claim 7, further comprising the GUI being configured for specifying the customized inquiry resolution process by defining a sequence of using the chosen at least two items.

9. The system of claim 7, further comprising the GUI being configured for specifying the customized inquiry resolution process by defining content for at least one of the chosen at least two items.

10. The system of claim 7, further comprising the GUI being configured for specifying the customized inquiry resolution process by defining how context is to be inserted into at least one of the chosen at least two items.

11. The system of claim 1, further comprising a graphical user interface (GUI) configured for creating the script.

12. The system of claim 1, further comprising a graphical user interface (GUI) configured for creating a template for the response to the user.

13. The system of claim 1, further comprising a graphical user interface (GUI) configured for creating a template for the response to the external computerized system.

14. The system of claim 1, further comprising a graphical user interface (GUI) configured for creating a template for the response to the case tracking system.

15. The system of claim 1, further comprising a graphical user interface (GUI) includes an authoring template that is used to create content to be provided by the system to at least one of the customer service agent and the user.

16. The system of claim 15, in which the authoring template provides at least one attribute for defining which particular context is substituted in the content that is created, thereby customizing the content to the particular user inquiry.

17. The system of claim 1, further comprising a graphical user interface (GUI) including a mapping tool for specifying at least one mapping between a condition set imposed on at least one context attribute and a corresponding customized user inquiry resolution process.

18. The system of claim 1, in which the context includes customer profile or account information.

19. The system of claim 1, in which the context is received by telemetry.

20. The system of claim 1, in which the context includes one or more electronic mail messages.

21. The system of claim 1, in which the context includes data entered into at least one web form.

22. The system of claim 1, in which the context includes one or more forum posts.

23. The system of claim 1, in which the context includes one or more natural language queries.

24. The system of claim 1, in which the context includes output from an interactive voice response system.

25. The system of claim 1, in which the context includes one or more instant messaging sessions.

26. The system of claim 1, in which the context includes output from a voice recognition system.

27. The system of claim 1, in which the context includes information about the customer service agent.

28. The system of claim 1, in which the knowledge engine further includes an authoring tool to create content.

29. The system of claim 1, in which the system further includes a GUI including an onscreen window that displays the context to the customer service agent.

30. The system of claim 1, in which the context is received from a case tracking system upon request to the case tracking system from the knowledge engine.

31. The system of claim 1, in which the context is received from a case tracking system upon request to the knowledge engine from the case tracking system.

32. The system of claim 1, in which the customized inquiry resolution process includes automatically providing a customized sequence of resolution acts for the customer service agent, each act invoking one of the items.

33. The system of claim 1, in which at least one of the at least two chosen items is customized using the context.

34. The system of claim 1, in which at least one of the at least two chosen items includes content that is customized using the context.

35. The system of claim 1, further including a user interface to control a rules engine that performs the customization, the user interface performing the control by using textual input from the user without using programmatic input and without using a specialized scripting language.

36. A computer-implemented method comprising:
obtaining context relevant to a user inquiry;
automatically configuring a customized inquiry resolution process, which is particular to the user inquiry, by using the context; and
providing the customized inquiry resolution process to a customer service agent, wherein the customized inquiry resolution process includes at least two of the following items:
automatically performing a computerized search using the context;
providing, to the customer service agent, a particular script;
providing a collaborative communication session for collaborating with or escalating to another customer service agent;
providing a response template to respond to the user;
providing a response template to respond to an external computerized case tracking system;
providing a response template to respond to an external computerized system;
providing at least one content file to the agent; and
initiating an interaction with another computerized system.

37. The method of claim 36, in which the customized inquiry resolution process is selected by matching at least one attribute of the context of the user query against a condition set defining a particular one of several possible customized inquiry resolution processes.

38. The method of claim 36, in which the customized inquiry resolution process defines a sequence for the customer service agent to use the chosen at least two items.

39. The method of claim 36, in which the customized inquiry resolution process includes choosing content for at least one of the chosen at least two items.

40. The method of claim 36, in which the customized inquiry resolution process includes inserting at least some of the context into content for at least one of the chosen at least two items.

41. The method of claim 36, further including using the content for customizing at least one of the at least two chosen items.

42. The method of claim 36, further comprising defining the customized inquiry resolution process by choosing the at least two items.

43. The method of claim 42, further comprising defining the customized inquiry resolution process by choosing a sequence of using the chosen at least two items.

44. The method of claim 42, further comprising defining the customized inquiry resolution process by defining content available for the customized inquiry resolution process.

45. The method of claim 42, further comprising defining the customized inquiry resolution process by defining how context is to be inserted into at least one of the chosen at least two items.

46. The method of claim 36, further comprising creating the script.

47. The method of claim 36, further comprising creating a template for the response to the user.

48. The method of claim 36, further comprising creating a template for the response to the external computerized system.

49. The method of claim 36, further comprising creating a template for the response to the case tracking system.

50. The method of claim 36, further comprising creating content to be provided by the system to at least one of the customer service agent and the user.

51. The method of claim 44, in which the creating content includes using at least one attribute for which particular context will be substituted in the content to customize the content to the user inquiry.

52. The method of claim 36, further including defining condition sets upon context that map to corresponding customized user inquiry resolution processes.

53. The method of claim 36, in which the obtaining the context includes obtaining the context at least in part from a computerized case tracking system.

54. The method of claim 53, in which the obtaining the context includes obtaining customer profile or account information.

55. The method of claim 36, in which the obtaining the context includes receiving the context by telemetry.

56. The method of claim 36, in which the obtaining the context includes obtaining one or more electronic mail messages.

57. The method of claim 36, in which the obtaining the context includes obtaining data entered into one or more web forms.

58. The method of claim 36, in which the obtaining the context includes obtaining one or more forum posts.

59. The method of claim 36, in which the obtaining the context includes obtaining one or more natural language queries.

60. The method of claim 36, in which the obtaining the context includes obtaining output from an interactive voice response system.

61. The method of claim 36, in which the obtaining the context includes receiving information from at least one instant messaging session.

62. The method of claim 36, in which the obtaining the context includes receiving output from a voice recognition system.

63. The method of claim 36, in which the obtaining the context includes obtaining information about the customer service agent.

64. The method of claim 36, further comprising displaying the context to a customer service agent as part of the customized inquiry resolution process.

65. The method of claim 36, in which the obtaining the context includes requesting and then receiving the context from a case tracking system.

66. The method of claim 36, in which the obtaining the context includes responding to a request from a case tracking system and then receiving the context from the case tracking system.

67. The method of claim 36, in which the configuring the customized inquiry resolution process includes automatically providing a customized sequence of resolution acts for the customer service agent.

68. The method of claim 36, further comprising using the context to customize at least one of the collaborating with or escalating to another customer service agent and the interaction with another computerized system.

69. The method of claim 36, in which the configuring the customized inquiry resolution process includes providing customized content.

70. The method of claim 36, further including controlling the configuring of the customized inquiry resolution process by textual input without using programming input or a specialized scripting language.

71. A computer readable medium for performing the acts recited in claim 36.

72. A computer-implemented system comprising:
a communication interface module operable to communicate with a computer-implemented case tracking module that tracks cases representing customer inquiries, the case tracking module including context associated with each case;
a customer service agent user interface including a display device; and
a knowledge engine, coupled to the communication interface module and receiving the context from the case tracking system associated with a particular case, the knowledge engine operable to automatically consider context from the case tracking system to configure a customized case resolution process for the particular case, the customized case resolution process including at least two customized items selected from:
(1) a search engine that automatically performs a search that is customized using context from the case tracking system;
(2) a scripted dialog, between the customer service agent and the customer, that is customized using context from the case tracking system;
(3) a collaborative or escalative session with another customer service agent that is customized using context from the case tracking system;
(4) a response to the customer that is customized using context from the case tracking system;
(5) a response to the case tracking system that is customized using context from the case tracking system;
(6) at least one content file that is customized using context from the case tracking system; and
(7) an interaction with another computerized system that is customized using context from the case tracking system.

73. The system of claim 72, in which the display device includes an onscreen window that is configured to display to the customer service agent the context from the case tracking system.

74. The system of claim 72, in which the receiving the context from the case tracking system is initiated by the knowledge engine.

75. The system of claim 72, in which the receiving the context from the case tracking system is initiated by the case tracking system.

76. The system of claim 72, in which the customized case resolution process includes a customized sequence for use of the at least two items by the customer service agent.

77. The system of claim 76, in which the customized sequence can be overridden by the customer service agent.

78. A method comprising:
receiving from a computerized case tracking module context about a case representing a customer inquiry;
configuring, by considering the context, a customized case resolution process that is particular to the case;
providing the customized case resolution process to a customer service agent; and
wherein the customized case resolution process includes at least two of:
automatically performing a computerized search that is customized using the context;
providing to the customer service agent or customer a script that is customized using the context;
collaborating with or escalating to another customer service agent, using the context;
providing a response to the customer that is customized using the context;
providing a response to the case tracking system that is customized using the context;
providing at least one content file that is selected using context from the case tracking system; and
initiating an interaction with another computerized system, the interaction customized using the context.

79. The method of claim 78, in which the receiving context additionally includes receiving other context from a source other than the case tracking module, and the configuring the customized case resolution process includes using the other context.

80. The method of claim 78, further comprising displaying the context from the case tracking system to the customer service agent.

81. The method of claim 78, in which the receiving the context from the case tracking system is initiated by the knowledge engine.

82. The method of claim 78, in which the receiving the context from the case tracking system is initiated by the case tracking system.

83. The method of claim 78, in which the providing the customized case resolution process to a customer service agent includes providing a customized sequence of resolution steps for the customer service agent.

84. The system of claim 78, in which the customized sequence is capable of being overridden by the customer service agent.
